(19) United States
(12) Patent Application Publication
(10) Pub. No.: US 2009/0021519 A1
(43) Pub. Date: Jan. 22, 2009

(54) DATA DISTRIBUTION DEVICE AND DATA DISTRIBUTION METHOD

(75) Inventor: Atsushi Yusa, Tokyo (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: OKI ELECTRIC INDUSTRY CO., LTD., Tokyo (JP)

(21) Appl. No.: 12/140,339

(22) Filed: Jun. 17, 2008

(30) Foreign Application Priority Data
Jul. 19, 2007 (JP) 2007188716

(51) Int. Cl. G06F 13/00

(52) U.S. Cl. 345/536

(57) ABSTRACT

A data distribution device includes a pair of first storage units, a second storage unit which includes a dual-port memory, a write unit which repeatedly writes drive data into one of the pair of first storage units and thereafter writes the remaining drive data and a read output unit which outputs the respective concurrently read drive data to the k corresponding drive circuits concurrently, where read addresses read from the dual-port memory are not overtaken by write addresses written to the dual-port memory during the period in which reading and writing of the drive data are being simultaneously performed with respect to the dual-port memory of the second storage unit.

### CROSS-REFERENCE TO RELATED APPLICATION

This application claims priority under 35 USC 119 from Japanese Patent Application No. 2007-188716, the disclosure of which is incorporated by reference herein.

### BACKGROUND OF THE INVENTION

1. Field of the Invention

The present invention relates to a data distribution device and a data distribution method. More particularly, it relates to a data distribution device in which drive data of all data lines of a display apparatus as inputted from a data source are concurrently outputted to a plurality of drive circuits for driving the respective data lines of the display apparatus, and a data distribution method which is applicable to the data distribution device.

2. Description of the Related Art

A display apparatus (for example, a TFT (Thin Film Transistor)-LCD (Liquid Crystal Display)) in which a large number of data lines and a large number of gate lines are respectively disposed along an X direction and along a Y direction, is provided with a timing controller which includes a semiconductor integrated circuit and which controls the driving of the display apparatus. In a timing controller of this type, RGB data for one line, which consists of pixels of the same gate line, and a synchronizing signal are inputted from a data source such as a graphic processor or the like. In each cycle of the synchronizing signal, The timing controller controls the drive of the display apparatus by executing a process in which RGB data inputted from the data source are sequentially stored in a line memory or the like, and RGB data of one line inputted in the previous cycle and stored in a line memory or the like are sequentially supplied to source drivers and drive the respective data lines, together with control signals, and the control signals are supplied to gate drivers for driving the respective gate lines.

When the number of pixels of a display apparatus is large, such as with an HDTV (1920×1080 pixels), there is adopted a configuration in which, in order to decrease the data transfer rate between a timing controller and source drivers, data lines disposed in the display apparatus are divided into two groups, a source driver which drives one of the data line groups (for example, a data line group arranged on the left side of the display apparatus), and a source driver which drives the other data line group (for example, a data line group arranged on the right side of the display apparatus) are respectively disposed, and the timing controller concurrently performs the supply of left side RGB data to the source driver for driving the data line group arranged on the left side and the supply of right side RGB data to the source driver for driving the data line group arranged on the right side.

More specifically, as shown in FIG. 11, in order to concurrently write RGB data inputted from a data source into a memory and read the RGB data from a memory (that is, perform the supply of the RGB data to the source driver), the timing controller is provided with two line memories (line memory-0 and line memory-1) each of which having a storage capacity capable of storing the RGB data of one line (an address space for one line (for example, 1 to 1920)), as line memories for storing the RGB data. Each of the individual line memories includes two RAMs (RAM-0 and RAM-1, or RAM-2 and RAM-3) in order to concurrently read the left side RGB data from the memory and supply it to the source driver, and read the right side RGB data from the memory and the supply it to the source driver.

The operation of the timing controller shown in FIG. 11 is shown in FIG. 12. Image data for one line inputted from the data source are formed of a leading synchronizing signal and subsequent RGB data. In a cycle in which image data of a first line are inputted, the write address of a line memory-0 is changed from “1” to “1920”, and the RGB data of the first line are sequentially written into the RAM-0 and RAM-1 of the line memory-0. When the RGB data of one line have been written into the line memory-0, the RGB data of one line are read from the line memory-0. More specifically, the read address is changed from “1” to “960” for the RAM-0, and the RGB data read from the RAM-0 are sequentially outputted as the left side RGB data to the source driver which drives the left side data line group. Concurrently with the output of the left side RGB data, the read address is changed from “961” to “1920” for the RAM-1, and the RGB data read from the RAM-1 are sequentially outputted as the right side RGB data to the source driver which drives the right side data line group. In addition, when the next cycle, in which the image data of the second line are inputted from the data source has arrived, and after the start of the reading of the RGB data from the line memory-0, the write address of the line memory-1 is changed from “1” to “1920”, and the RGB data of the second line are sequentially written into the RAM-2 and RAM-3 of the line memory-1. In this manner, the memory that writes or reads the RGB data alternates between the line memory-0 and the line memory-1, and the RGB data, which are continuously inputted from the data source, are concurrently distributed and outputted to the plurality of source drivers.

As a technique relevant to the above, JP-A No. 2003-195821 discloses a technique in which external video data of the previous horizontal line are stored in one line memory, and external video data of the current horizontal line are stored in another line memory; the exclusive logical sums of the external video data stored in the same addresses of both the line memories are calculated for each bit; and a signal of the inverted calculated result and a polarity signal indicating negative polarity, or a signal of the calculated result itself and a polarity signal indicating positive polarity, whichever has the least number of bits changed from the previous internal video data, is transmitted as current internal video data, thereby reducing power consumption and reducing an EMI radiation level when displaying an image which repeats over a plurality of lines and has a pattern in which the display states of pixels in the same line change frequently.

However, in the foregoing case, in which the data lines of the display apparatus are divided into the plurality of data line groups, the plurality of source drivers corresponding to the individual data line groups are respectively disposed, and the timing controller is configured so as to concurrently perform the outputs of the data to the respective source drivers (for example, the outputs of the left side RGB data and the right side RGB data), the two sets of line memories for storing the RGB data need to be disposed in dualized fashion as stated above, and hence, there is a problem in that the power consumption of the timing controller increases greatly. There is also a problem in that, since the line memories are dualized, the chip size of the timing controller increases.

### SUMMARY OF THE INVENTION

The present invention has been made in view of the above circumstances and provides a data distribution device and a data distribution method.

A first aspect of the present invention provides a data distribution device connected to k (where k≧2) drive circuits which are respectively disposed in correspondence with individual data line groups in which data lines disposed in a display apparatus are divided into data line groups numbering k, and the k drive circuits drive the individual data lines of the respectively corresponding data line groups. The data distribution device includes, each of which having a storage capacity capable of storing drive data of data line groups numbering i (where i<k), a second storage unit which comprises a dual-port memory capable of simultaneously writing and reading data, and which has a storage capacity capable of storing the drive data of j (where j=k−i) data line groups, a write unit which repeatedly writes, from among the drive data of all the data lines of the display apparatus inputted every cycle from a data source in a fixed sequence, the drive data for the i data line groups from the start thereof in the fixed input sequence, into one of the pair of first storage units, and thereafter writes the remaining drive data of j data line groups into the second storage unit such that at least drive data which are in a memory at which reading and writing of drive data takes place during the same period are written into the dual-port memory of the second storage unit, and alternates every cycle the one of the pair of first storage units into which the drive data are written, and a read output unit which, after completion of the writing of the drive data by the write unit, concurrently reads the drive data to be outputted to the k drive circuits, from the one of the pair of first storage units into which the latest drive data have been written, and from the second storage unit, and which outputs the respective concurrently read drive data to the k corresponding drive circuits concurrently. In the data distribution device, read addresses read from the dual-port memory are not overtaken by write addresses written to the dual-port memory during the period in which reading and writing of the drive data are being simultaneously performed with respect to the dual-port memory of the second storage unit.

In the first aspect, the k (where k≧2) drive circuits are respectively disposed in correspondence with the individual data line groups in which the data lines disposed in the display apparatus are divided into the k data line groups, and the k drive circuits have the function of driving the individual data lines of the corresponding data line groups. The data distribution device stated in the first aspect is connected with the k drive circuits, and the drive data of all the data lines of the display apparatus are inputted thereto every cycle from the data source in the fixed sequence. Here, when the drive data inputted from the data source every cycle are written into the storage unit and where, after the end of writing, the drive data are successively read from the storage unit and are concurrently outputted to the k drive circuits, the write speed of the drive data into the storage unit (the changing speed of the write addresses) becomes approximately k times the read speed of the drive data from the storage unit (the changing speed of the read addresses) (In FIG. 12, for example, k=2, and the gradient of the changes of the write addresses becomes double the gradient of the changes of the read addresses).

For this reason, during writing the drive data into the storage unit, regarding the group of drive data which are written into the storage unit at an early stage (in FIG. 12, for example, the group of drive data corresponding to addresses “1” to “960”) among the drive data of all the data lines of the display apparatus, the read addresses of the drive data of a certain line are overtaken by the write addresses of the drive data of the next line midway of the read of the drive data of the certain line (in FIG. 12, for example, when note is taken of a cycle in which the data of the second line are inputted, the write address into a line-1 exceeds “960” before the read address from the RAM-0 of a line memory-0 reaches “960”). Therefore, even if a single storage unit capable of simultaneously writing and reading the data is employed as the storage unit for storing the group of drive data (for example, the RAM-0 of the line memory-0 and the RAM-2 of a line memory-1 in FIG. 12), the read addresses will be overtaken by the write addresses midway of the read, and the drive data will be rewritten before being read, so that the storage unit for storing the group of drive data must be dualized.

On the other hand, regarding the group of drive data which are written into the storage unit at a late stage (in the example of FIG. 12, the group of drive data corresponding to addresses “961” to “1920”) among the drive data of all the data lines of the display apparatus, the read addresses of the drive data of a certain line are not overtaken by the write addresses of the drive data of the next line midway of the read of the drive data of the certain line (in FIG. 12, for example, when note is taken of a cycle in which the data of the second line are inputted, the write address into the line-1 reaches “1920” after the read address from the RAM-1 of the line memory-0 has reached “1920”). Therefore, a single storage unit capable of simultaneously writing and reading the data can be employed as the storage unit for storing the group of drive data (for example, the RAM-1 of the line memory-0 and the RAM-3 of the line memory-1 in FIG. 12). In this case, the read addresses are not overtaken by the write addresses midway of the read (the drive data are not rewritten before being read).

On the basis of the above, in the first aspect, the data distribution device includes the pair of first storage units, each of which having a storage capacity capable of storing the drive data of the i (where i<k) ones of data line groups, and the dual-port memory which can simultaneously writing and reading the data, and it is provided with the second storage unit which has a storage capacity capable of storing the drive data of the j (where j=k−i) data line groups. And, an ordinary memory (for example, RAM) is suitable as the first storage unit. The second storage unit may include, for example, only of the dual-port memory. However, when the second storage unit is divided into a plurality of memories and where the drive data of the data lines different from one another are written into the respective memories, a period for which the read and write of the drive data are being respectively performed from and into the second storage unit is separated into a period or periods for which the read and write of the drive data are being performed from and into the different memories, and a period for which the read and write of the drive data are being performed from and into the identical memory, and the read and write of the drive data are not simultaneously performed from and into some of the plurality of memories, so that ordinary memories (RAMs) can be employed for some memories. Accordingly, the second storage unit may also include, for example, the dual-port memory and the memory.

Furthermore, in the first aspect the write unit repeats writing, among the drive data of all the data lines of the display apparatus that are inputted every cycle from a data source in a fixed sequence, the drive data for the i data line groups from the head in terms of the fixed input sequence into either one of the pair of first storage units, thereafter writing the remaining drive data for j data line groups into the second storage unit in a manner that at least the drive data that a memory into which the drive data is written is to be read in a period for which the drive data are being written may be written into the dual-port memory of the second storage unit; and switching every cycle the first storage unit into which the drive data are written. In addition, after the completion of the write of the drive data by the write unit, the read output unit concurrently reads the drive data to be outputted to the k drive circuits, from that first storage unit of the pair of first storage units into which the latest drive data are written, and the second storage unit, and it outputs the drive data concurrently read, to the corresponding ones of the k drive circuits concurrently. Further, as stated in the first aspect, the data distribution device is so configured that the read addresses from the dual-port memory are not overtaken by the write addresses into the dual-port memory, in the period for which reading and writing of the drive data are being simultaneously performed from and into the dual-port memory of the second storage unit.

In this manner, in the first aspect, the storage unit into which, among the drive data of all the data lines of the display apparatus as inputted in the fixed sequence from the data source every cycle, the drive data for the i data line groups from the head in terms of the input sequence from the data source are written, is dualized (the pair of first storage units are disposed), but the second storage unit which includes the dual-port memory is employed as the storage unit into which the remaining drive data (the drive data for the j data line groups) are written, and at least the drive data to be read from the memory in the period for which the remaining drive data into the second storage unit are being written into the same memory are written into the dual-port memory of the second storage unit. Therefore, the second storage unit need not be dualized, and only one second storage unit is disposed, whereby dissipation power when the drive data of the display apparatus as inputted from the data source are concurrently distributed and outputted to the plurality of (k) drive circuits can be reduced.

The dual-port memory forming a part or the entirety of the second storage unit is larger in area than the ordinary memory of the same capacity in correspondence with its dual-port portion, but in the data distribution device stated in the first aspect, the second storage unit need not be dualized, and the proportion of the area of the dual-port portion as occupied in the area of the whole dual-port memory lowers as the storage capacity of the dual-port memory enlarges. Therefore, in an aspect in which the storage capacity of the second storage unit is set at a predetermined capacity or more in the data distribution device stated in the first aspect (for example, in an aspect in which the second storage unit is set at a storage capacity capable of storing the drive data of the data lines of ½ of the total number of data lines), the decrement of the area owing to the non-dualization of the second storage unit becomes much larger than the increment of the area of the dual-port portion, and there is attained the advantage that the chip size of the second storage unit can be reduced, irrespective of whether the second storage unit is configured of the dual-port memory only or the dual-port memory and the memory.

When the second storage unit includes only the dual-port memory in the first aspect, the data distribution device can be configured, for example, so that the write unit may write all the remaining drive data into the dual-port memory of the second storage unit, while the read output unit may concurrently perform the first read process in which the drive data to be outputted to the i drive circuits are read from the first storage unit where the latest drive data are written, and the second read process in which the drive data to be outputted to the j drive circuits are read from the dual-port memory of the second storage unit, whereby the drive data to be outputted to the k drive circuits are concurrently read.

By way of example, in a second aspect, i=j=1 holds when the number of the drive circuits (the number of the data line groups); k is 2, each of the pair of first storage units has a storage capacity capable of storing the drive data of the data lines of ½ of the total number of data lines disposed in the display apparatus, and the second storage unit is configured only of the dual-port memory which has a storage capacity capable of storing the drive data of the data lines of ½ of the total number of data lines. In addition, by the write unit, among the drive data of all the data lines of the display apparatus as inputted in the fixed sequence from the data source every cycle, the drive data for one data line group from the head in terms of the input sequence from the data source (the drive data of the data lines of ½ of the total number of data lines) are written into one of the pair of first storage units, and the remaining drive data (the drive data of the data lines of ½ of the total number of data lines) are thereafter written into the dual-port memory of the second storage unit. By the read output unit, the first read process in which the drive data to be outputted to one drive circuit are read from the first storage unit where the latest drive data are written, and the second read process in which the drive data to be outputted to one drive circuit are read from the dual-port memory of the second storage unit, are concurrently performed, whereby the drive data to be outputted to the two drive circuits are concurrently read. In this aspect, the storage capacity of the second storage unit becomes ½ of the storage capacity capable of storing the drive data of the data lines of the total number of data lines disposed in the display apparatus, and hence, there is attained the advantage that the chip size can be reduced as stated before.

Besides, in the first aspect, when the second storage unit includes the dual-port memory and the memory, the data distribution device can be configured, for example, so that the write unit writes the remaining drive data separately into the dual-port memory and the memory of the second storage unit in order that among the remaining drive data, at least the drive data to be read from the memory in the period for which the drive data are being written into the same memory may be written into the dual-port memory of the second storage unit, while the other drive data may be written into the memory of the second storage unit, and that the read output unit concurrently performs the first read process in which the drive data to be outputted to the i drive circuits are read from the first storage unit where the latest drive data are written, and the second read process in which the drive data to be outputted to the j drive circuits are read from the second storage unit including the dual-port memory and the memory, whereby the drive data to be outputted the k drive circuits are concurrently read.

In the second aspect or a third aspect, the numbers k and i of the drive circuits are constant with the number i being at least 2, the read output unit needs to concurrently read the two or more drive data from the first storage unit. In addition, when the data distribution device of the invention is connected to the display apparatus in which the number of the drive circuits (the number of the data line groups); k is different, the number k of the drive circuits might be altered. Here, also when the value of the number i changes with the alteration of the number k of the drive circuits and where the largest value of the number i is at least 2, the read output unit needs to concurrently read the two or more drive data from the first storage unit if the number i is at least 2.

In consideration of this fact, when the numbers k and i of the drive circuits are constant with the number i being at least 2, or where a value of the number i changes with the alteration of the number k of the drive circuits, with the largest number of the number i being at least 2, in the second aspect or the third aspect, the data distribution device may preferably be configured, for example, so that each of the pair of first storage units is divided into m memories where m equals to the value of the constant number of i or the maximum number of i, and each of which has a storage capacity capable of storing the drive data of all the data lines of the single data line group; that the write unit writes the drive data for the i data line groups from the head in terms of the input sequence from the data source, successively into the m memories, of one of the pair of first storage units; and that when the value of the number i is at least 2, the read output unit performs the first read process in which the drive data are concurrently read in such a manner that each of the drive data corresponds to each of the i memory groups at the time when the memories equal in number to the value of the number i or the largest value thereof, of the first storage unit where the latest drive data are written are divided into the i memory groups, whereby the drive data to be outputted to the i drive circuits are concurrently read from the first storage unit. Thus, it is permitted to concurrently read the i (two or more) drive data from the first storage unit.

The configuration in which, in any aspect of the invention, the read addresses from the dual-port memory are not overtaken by the write addresses into the dual-port memory, in the period where reading and writing of the drive data are being simultaneously performed from and into the dual-port memory of the second storage unit, can be realized by, for example, a configuration in which, the write unit switches every cycle, the write sequence of the drive data into the plurality of memories constituting the second storage unit and including the dual-port memory, or a configuration in which, the read output unit reads the drive data at a preset read speed in order that the length of the read period of the drive data in every cycle may become a predetermined value or less. Thus, it is possible to avoid the drawback that the read addresses from the dual-port memory are overtaken by the write addresses into the dual-port memory, and in consequence the drive data written into the dual-port memory are rewritten before being read.

In the third aspect, when the number of the drive circuits k is 2 or 4, the data distribution device may preferably be configured such that each of the pair of first storage units includes two memories, each of which having a storage capacity capable of storing the drive data of the data lines of ¼ of the total number of the data lines disposed in the display apparatus; that the second storage unit includes two dual-port memories each of which having a storage capacity capable of storing the drive data of the data lines of ⅛ of the total number of the data lines, and two memories, each of which having a storage capacity capable of storing the drive data of the data lines of ⅛ of the total number of the data lines; and that the write unit writes the drive data for the data lines of ½ of the total number of the data lines, from the starts thereof in the input sequence from the data source, successively into the two memories of one of the pair of first storage units, writes the drive data for the next ⅛ of the data lines into one of the two memories of the second storage unit, writes the drive data for the next ⅛ of the data lines into one of the two dual-port memories of the second storage unit, the drive data for the next ⅛ of the data lines into the other of the two dual-port memories of the second storage unit, and the drive data for the final ⅛ of the data lines into the other of the two memories of the second storage unit Here, when the number of the drive circuits k is 2, the read output unit performs the first read process in which the drive data to be outputted to the single drive circuit are successively read from those two memories of the first storage unit into which the latest drive data has been written, and it performs the second read process, which is concurrent with the first read process, and in which the drive data to be outputted to the single drive circuit are successively read from one of the two memories of the second storage unit, from one of the two dual-port memories of the second storage unit, from the other of the two dual-port memories of the second storage unit and from the other of the two memories of the second storage unit. On the other hand, when the number of the drive circuits k is 4, the read output unit performs the first read process in which the drive data to be outputted to the two drive circuits are read from those two memories of the first storage unit into which the latest drive data have been written, and it performs the second read process which is concurrent with the first read process, and in which the drive data to be outputted to the single drive circuit are successively read from one of the two memories of the second storage unit and from one of the two dual-port memories of the second storage unit, while the drive data to be outputted to the single drive circuit are successively read from the other of the two memories of the second storage unit and from the other of the two memories of the second storage unit.

In the above aspect, the operation in which the drive data are concurrently outputted to the two drive circuits, respectively, when the number k of the drive circuits is 2, and the operation in which the drive data are concurrently outputted to the four drive circuits, respectively, when the number of the drive circuits k is 4, can be realized without altering the configurations of the first storage units and the second storage unit, so that the versatility of the data distribution device according to the invention can be enhanced. Moreover, also in the above aspect, the storage capacity of the second storage unit becomes the largest (the storage capacity capable of storing the drive data of the data lines of ½ of the total number of the data lines disposed in the display apparatus), so that the advantage of the reduction of the chip size as stated before is attained.

A fourth aspect of the present invention provides a data distribution method where drive data of all data lines of a display apparatus are inputted in a fixed sequence from a data source every cycle and are distributed to k (where k≧2) drive circuits which are respectively disposed in correspondence with individual data line groups, and wherein data lines disposed in the display apparatus are divided into k data line groups, and which drive the individual data lines of the respectively corresponding data line groups. The data distribution method includes repeatedly writing, from among the drive data of all the data lines of the display apparatus that are inputted every cycle from the data source in the fixed sequence, drive data of the i (where i<k) data line groups from the start in terms of the fixed input sequence into one of the pair of first storage units, each of which has a storage capacity capable of storing the drive data of the i data line groups, and thereafter writing the remaining drive data of j data line groups (where j=k−i) into a second storage unit, which includes a dual-port memory capable of simultaneously writing and reading of the data and which has a storage capacity capable of storing the drive data for the j data line groups, such that at least the drive data which are in a memory at which the drive data is written is to be read in a period for which the drive data are being written, may be written into a dual-port memory of the second storage unit, and switching every cycle the first storage unit into which the drive data are written; and concurrently reading after completion of the write of the drive data by the write unit, the drive data to be outputted to the k drive circuits, from that one of the pair of first storage units into which the latest drive data are written, and the second storage unit, and concurrently outputting the respective drive data concurrently read, to the k corresponding drive circuits. Therefore, likewise to the data distribution device stated in the first aspect, the data distribution method can reduce dissipation power when the drive data of the display apparatus as inputted from the data source are concurrently distributed and outputted to the plurality of drive circuits.

### BRIEF DESCRIPTION OF THE DRAWINGS

FIG. 1 is a block diagram showing the schematic configuration of a display apparatus according to the first embodiment of the present invention;

FIG. 2 is a block diagram showing the configuration of the principal portions of a timing controller according to the first embodiment;

FIG. 3 is a timing chart showing the write and read timings of data into and from individual RAMs and the respective waveforms of the various control signals thereof in the timing controller in FIG. 2;

FIG. 4 is a block diagram showing the schematic configuration of a display apparatus according to the second embodiment;

FIG. 5 is a block diagram showing the configuration of the principal portions of a timing controller according to the second embodiment;

FIG. 6 is a timing chart showing the write and read timings of data into and from the individual RAMs of the timing controller in FIG. 5;

FIG. 7 is a timing chart showing the respective waveforms of various control signals in the timing controller in FIG. 5;

FIG. 8 is a block diagram showing the other configuration of the principal portions of the timing controller according to the second embodiment;

FIG. 9 is a timing chart showing the other timings of those writes and reads of data into and from individual RAMs which are realized by the timing controller in FIG. 8;

FIG. 10 is a timing chart showing the respective waveforms of various control signals for realizing the timings shown in FIG. 9;

FIG. 11 is a schematic block diagram showing the configuration of a timing controller in the related art; and

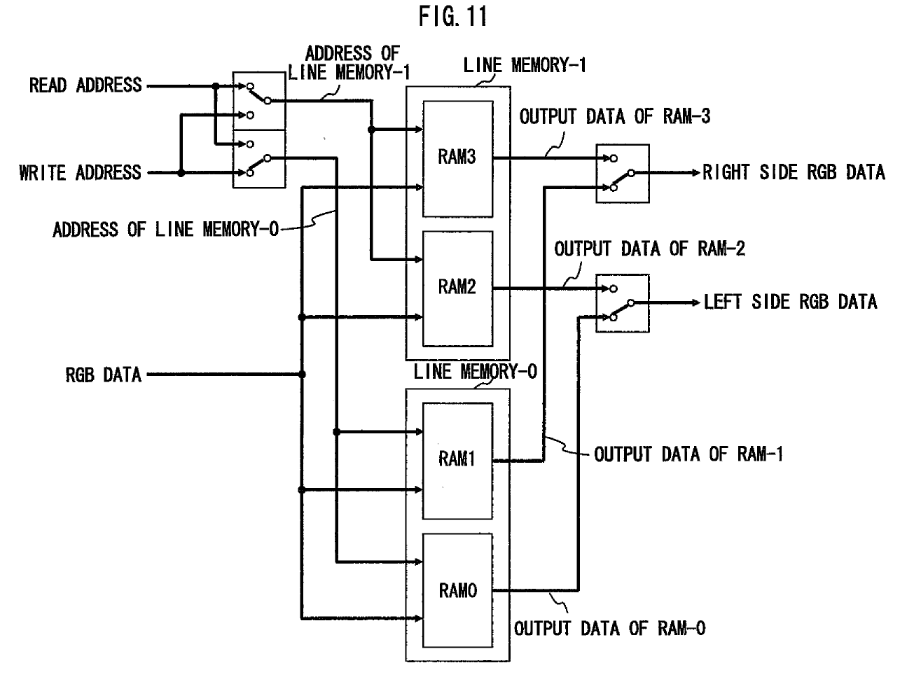

FIG. 12 is a timing chart for explaining the operation of the timing controller shown in FIG. 11.

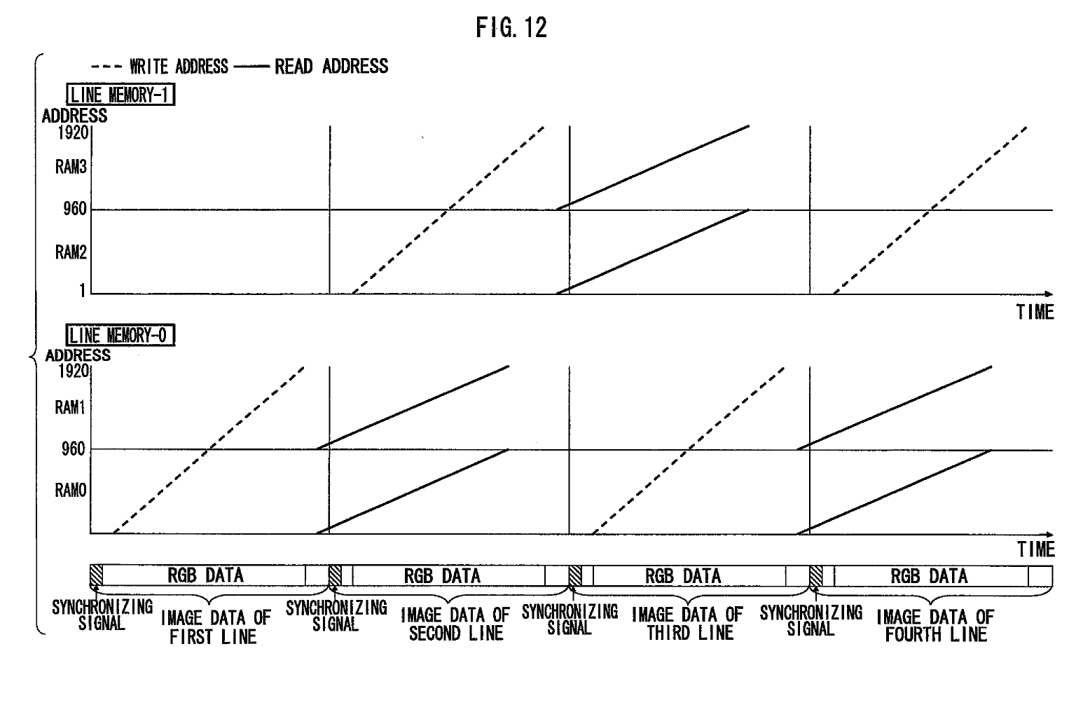

### DETAILED DESCRIPTION OF THE INVENTION

Examples of embodiments of the present invention will be described in detail with reference to the drawings. In the ensuing description, numerical values forming no hindrance to the invention will be mentioned, but the invention shall not be restricted to the numerical values stated below.

### First Embodiment

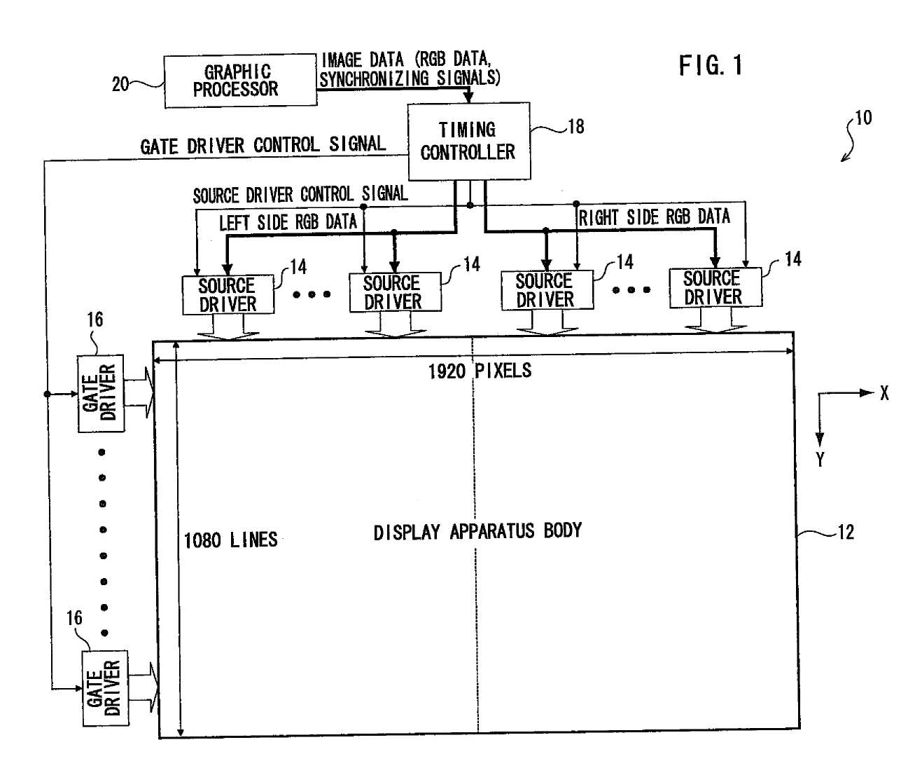

FIG. 1 shows a display apparatus 10 according to the first embodiment. The display apparatus 10 is configured such that peripheral circuits are connected to the display apparatus body 12 made up of a TFT-LCD or the like. When the display apparatus body 12 is the TFT-LCD, it has a configuration, not shown, as stated below. A liquid crystal is enclosed between a pair of transparent substrates which are arranged in opposition at a predetermined spacing. An electrode is formed on the whole area of the opposing surface of one of the transparent substrates. A large number of (for example, 1920) data lines which are arranged at fixed intervals along an X direction in FIG. 1 and which are respectively extended along a Y direction in FIG. 1, a large number of (for example, 1080) gate lines which are arranged at fixed intervals along the Y direction in FIG. 1 and which are respectively extended along the X direction in FIG. 1, and thin film transistors (TFTs) as well as electrodes which are respectively arranged at the intersection positions (pixel positions) between the individual data lines and the individual gate lines, are respectively disposed on the opposing surface of the other transparent substrate. Each individual TFT has its source connected to the corresponding electrode, has its gate connected to the corresponding gate line and has its drain connected to the corresponding data line.

In this embodiment, the individual data lines disposed in the display apparatus body 12 are assigned addresses “1” to “1920” successively from the data line which is located on the left end side of the display apparatus body 12 in FIG. 1. Besides, the display apparatus body 12 is not limited to the TFT-LCD, but it may well be another known display, for example, a plasma display or an organic EL display.

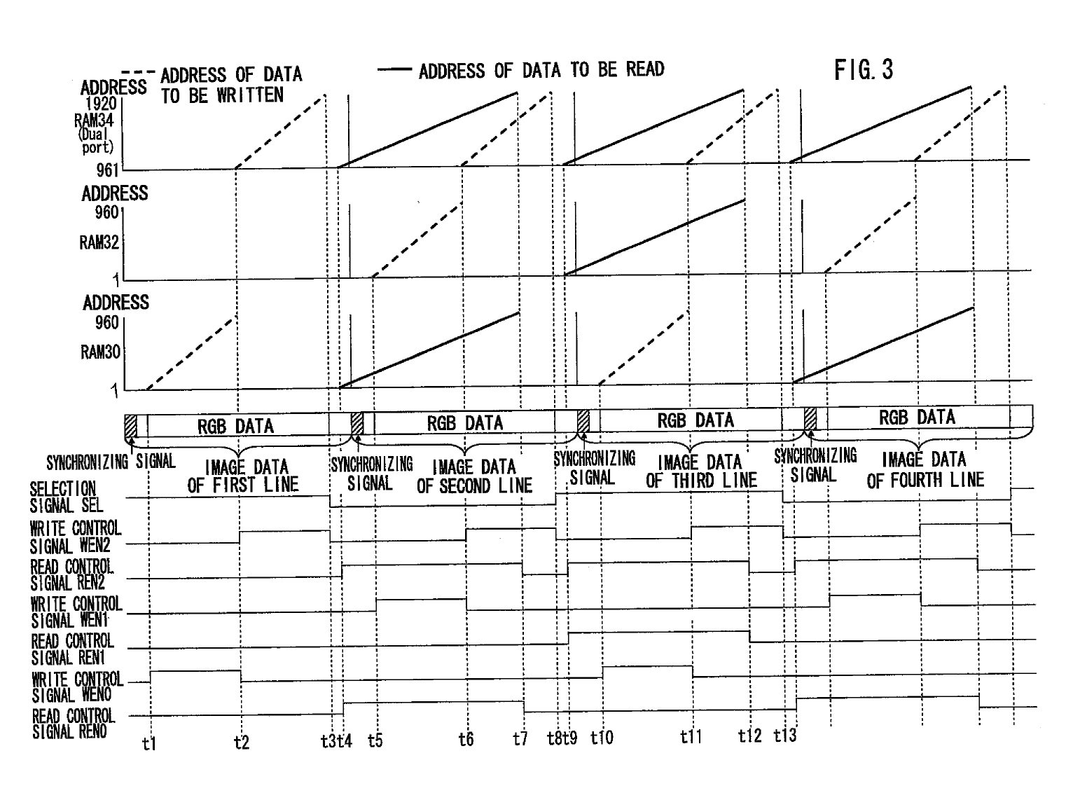

A plurality of source drivers 14 are added to the display apparatus body 12, and the individual data lines of the display apparatus body 12 are respectively connected to any of the plurality of source drivers 14. A plurality of gate drivers 16 are respectively connected to a timing controller 18, and the timing controller 18 is connected to a graphic processor 20. The graphic processor 20 retains image data expressive of an image to be displayed on the display apparatus body 12, in a frame memory or the like. This graphic processor 20 outputs synchronizing signals (a horizontal synchronizing signal and a vertical synchronizing signal) in fixed cycles to the timing controller 18, and it outputs the image data for one line of the display apparatus body 12 along the X direction in FIG. 1 (RGB data expressive of the level of a data voltage to be supplied to the individual data lines of the display apparatus body 12), among the retained image data, to the timing controller 18 sequentially in the ascending order of the addresses of the data lines, in each cycle of the horizontal synchronizing signal (refer also to FIG. 3). As will be explained in detail later, the timing controller 18 writes the RGB data for one line inputted from the graphic processor 20, into memories once, and it thereafter reads the RGB data from the memories and outputs them to the respective source drivers 14.

Here, likewise to the output of the RGB data from the graphic processor 20 to the timing controller 18, the output of the RGB data from the timing controller 18 to the source drivers 14 can also proceed so as to output the RGB data for one line sequentially in the ascending order of the addresses of the data lines. In this embodiment, however, the number of pixels of the display apparatus body 12 (the numbers of the data lines, etc.) is large, and hence, in order to reduce the transfer rate of the RGB data from the timing controller 18 to the source drivers 14, the data lines disposed in the display apparatus body 12 are divided into the two groups of a data line group having addresses “1” to “960” and a data line group having addresses “961” to “1920” (one broken line which is added to the display apparatus body 12 shown in FIG. 1 indicates the position of the division into the two data line groups), while the plurality of source drivers 14 are divided into the two groups of a first source driver group connected to the data line group having the addresses “1” to “960” and a second source driver group connected to the data line group having the addresses “961” to “1920”.

In addition, as will be explained in detail later, the timing controller 18 concurrently executes a process in which the RGB data of the data line group having the addresses “1” to “960” (left side RGB data) are read from the memory and are sequentially outputted to the first source driver group, and a process in which the RGB data of the data line group having the addresses “961” to “1920” (right side RGB data) are read from the memory and are sequentially outputted to the second source driver group. Thus, the transfer time period of the RGB data from the timing controller 18 to the source drivers 14 is reduced to ½ of a transfer time period when the above concurrent processes are not executed. Besides, after each individual source driver 14 has been supplied with the RGB data of the data lines connected to itself, from the timing controller 18, it supplies the corresponding data lines with the data voltages of the levels expressed by the inputted RGB data, for a fixed period corresponding to a source driver control signal inputted from the timing controller 18.

In this manner, the timing controller 18 corresponds to a data distribution device, the display apparatus body 12 to a display apparatus, the graphic processor 20 to a data source, and each of the first source driver group and the second source driver group to a driver circuit of k=2.

The plurality of gate drivers 16 are added to the display apparatus body 12, and the individual gate lines of the display apparatus body 12 are respectively connected to any of the plurality of gate drivers 16. The plurality of gate drivers 16 are respectively connected to the timing controller 18, and they repeat supplying a gate signal to any one of the large number of gate lines of the display apparatus body 12 for a predetermined time period, while sequentially switching the gate line to which the gate signal is supplied, in accordance with gate driver control signals inputted from the timing controller 18. When the gate signal is supplied to a certain one of the gate lines, all the TFTs for one line connected to the pertinent gate line are turned ON, the data voltages which are supplied through the data lines connected to the individual TFTs turned ON are applied to the liquid crystal through the electrodes connected to the individual TFTs turned ON, and the light transmission factor of the liquid crystal is changed at respective pixel positions corresponding to the individual TFTs turned ON. Thus, an image for one line is displayed on the display apparatus body 12. In addition, an image is displayed on the display apparatus body 12 by repeating the above processes.

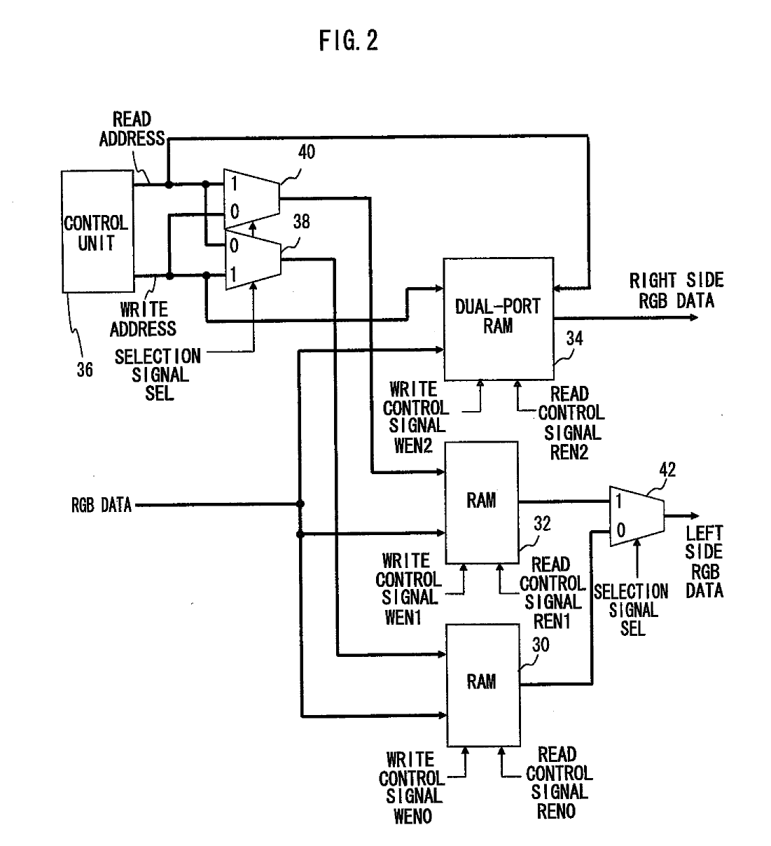

The configuration of (the principal portions of) the timing controller 18 will be described with reference to FIG. 2. The timing controller 18 includes a pair of RAMs (single-port RAMs) 30 and 32 each of which has a storage capacity capable of storing the drive data of the data lines of ½ of the total number of the data lines disposed in the display apparatus body 12. The RAMs 30 and 32 correspond to a pair of first storage units according to the invention (in this aspect, i=1 is held). Besides, the timing controller 18 includes a dual-port RAM 34 which has the same storage capacity as that of each of the RAMs 30 and 32 (that is, the storage capacity capable of storing the drive data of the data lines of ½ of the total number of the data lines) and which can simultaneously write and read the data. The dual-port RAM 34 corresponds to a second storage unit according to the invention (in more detail, a second storage unit) (in this aspect, j=1 is held). Data lines are connected to the data input terminals of the RAMs 30 and 32 and the dual-port RAM 34, and the RGB data are respectively inputted from the graphic processor 20 through the data lines.

The timing controller 18 includes a control unit 36 which generates and outputs a write address and a read address and also generates and outputs various control signals (write control signals WEN0 to WEN2, read control signals REN0 to REN2, and a selection signal SEL) on the basis of the synchronizing signals inputted from the graphic processor 20. The write enable input terminals and read enable input terminals of the RAMs 30 and 32 and dual-port RAM 34 are respectively connected to the control unit 36. Among the various control signals generated and outputted by the control unit 36, the write control signal WEN0 is inputted to the write enable input terminal of the RAM 30, the read control signal REN0 to the read enable input terminal of the RAM 30, the write control signal WEN1 to the write enable input terminal of the RAM 32, the read control signal REN1 to the read enable input terminal of the RAM 32, the write control signal WEN2 to the write enable input terminal of the dual-port RAM 34, and the read control signal REN2 to the read enable input terminal of the dual-port RAM 34. The control unit 36 corresponds to a write unit and a read output unit according to the invention (in more detail, a write unit and a read output unit), together with selectors 38, 40 and 42 to be stated below.

Furthermore, the timing controller 18 includes the selectors 38, 40 and 42. The two input terminals and selection signal input terminal of each of the selectors 38 and 40 are all connected to the control unit 36, the write address generated by the control unit 36 is inputted to one of the two input terminals of each of the selectors 38 and 40, the read address generated by the control unit 36 is inputted to the other of the two input terminals of each of the selectors 38 and 40, and the selection signal SEL generated by the control unit 36 is inputted to the selection signal input terminal of each of the selectors 38, 40 and 42. The write address input terminal and read address input terminal of the dual-port RAM 34 are connected to the control unit 36, and the write address and read address generated by the control unit 36 are also inputted to the dual-port RAM 34. In addition, the output terminal of the selector 38 and that of the selector 40 are respectively connected to the address input terminal of the RAM 30 and that of the RAM 32, and the address outputted from the selector 38 and the address outputted from the selector 40 are respectively inputted to the RAM 30 and RAM 32.

One and the other of the two input terminals of the selector 42 are respectively connected to the output terminal of the RAM 30 and that of the RAM 32, and data outputted from the RAMs 30 and 32 are respectively inputted to the selector 42. Besides, the output terminal of the selector 42 is connected to the first source driver group, and data outputted from the selector 42 are inputted to the first source driver group as the left side RGB data. In addition, the output terminal of the dual-port RAM 34 is connected to the second source driver group, and data outputted from the dual-port RAM 34 are inputted to the second source driver group as the right side RGB data.

Next, as the function of the first embodiment, the operation of the timing controller 18 according to the first embodiment will be described with reference to FIG. 3. As shown in FIG. 3, synchronizing signals are inputted from the graphic processor 20 to the timing controller 18 in fixed cycles (“synchronizing signals” shown in FIG. 3 are horizontal synchronizing signals, but vertical synchronizing signals are also inputted), and image data (RGB data) for one line are inputted thereto in the ascending order of the addresses of the data lines in a predetermined period within each cycle of the horizontal synchronizing signal (a period starting at the time a first predetermined time period after the timing of the input of the synchronizing signal (the timing t1 in FIG. 3), and ending at the time a second predetermined time period before the timing of the input of the next synchronizing signal (the timing t3 in FIG. 3): herein below, the period shall be termed the “write period”).

Among the various control signals generated and outputted by the control unit 36, the write control signals WEN0 to WEN2 and the read control signals REN0 to REN2 are at an L (low) level, and the selection signal SEL is at an H (high) level, at the beginning. The control unit 36 switches the write control signal WEN0 from the L level to the H level at a first predetermined time after the input of the synchronizing signal (a timing t1 in FIG. 3), and it sequentially generates and outputs changing write addresses in order that, among the RGB data for one line sequentially inputted, the RGB data for ½ line on the first half side may be all written successively from the head of the single RAM in the first half of the write period (a period of the timing t1 to a timing t2 in FIG. 3). Thus, in the period t1-t2 in FIG. 3, only the RAM 30 falls into a writable state, and the write addresses generated and outputted by the control unit 36 are inputted to the RAM 30, whereby the RGB data for the ½ line on the first half side (the RGB data of the data lines of the addresses “1” to “960”) among the RGB data of the first line sequentially inputted from the graphic processor 20 are written successively from the head of the RAM 30 in the first half of the write period of the RGB data of the first line (the period t1-t2 in FIG. 3).

The control unit 36 switches the write control signal WEN0 from the H level to the L level and also switches the write control signal WEN2 from the L level to the H level, at the timing of the end of the first half of the write period (the timing t2 in FIG. 3), and it sequentially generates and outputs changing write addresses in order that, among the RGB data for one line sequentially inputted, the RGB data for ½ line on the latter half side may be all written successively from the head of the single RAM in the latter half of the write period (a period of the timing t2 to a timing t3 in FIG. 3). Thus, in the period t2-t3 in FIG. 3, only the dual-port RAM 34 falls into a writable state, and the write addresses generated and outputted by the control unit 36 are inputted to the dual-port RAM 34, whereby the RGB data for the ½ line on the latter half side (the RGB data of the data lines of the addresses “961” to “1920”) among the RGB data of the first line sequentially inputted from the graphic processor 20 are written successively from the head of the dual-port RAM 34 in the latter half of the write period of the RGB data of the first line (the period t2-t3 in FIG. 3).

In addition, at the time when the write period of the RGB data of the first line has ended and when all the RGB data of the first line sequentially inputted from the graphic processor 20 have been written into the RAM 30 and the dual-port RAM 34 (at the timing t3 in FIG. 3), the control unit 36 switches the write control signal WEN2 from the H level to the L level and also switches the selection signal SEL from the H level to the L level.

When a third predetermined time period (shorter than the second predetermined time period) has lapsed from the end of the write period of the RGB data of the first line (at a timing t4 in FIG. 3), the control unit 36 switches each of the read control signals REN0 and REN2 from the L level to the H level, and it sequentially generates and outputs changing read addresses in order that the RGB data for ½ line may be read from each individual RAM in a period equal in length to the write period, from the switching point of time (hereinbelow, the period shall be termed the “read period”, and the read period of the RGB data of the first line is a period of the timing t4 to a timing t7 in FIG. 3) (in this case, the changing rate of the read addresses becomes ½ of that of the write addresses). Thus, in the read period t4-t7 in FIG. 3, the RAM 30 and the dual-port RAM 34 fall into readable states, and the read addresses generated and outputted by the control unit 36 are respectively inputted to the RAM 30 and the dual-port RAM 34, whereby the RGB data for ½ line on the first half side (the RGB data of the data lines of the addresses “1” to “960”), among the RGB data of the first line, and the RGB data for ½ line on the latter side (the RGB data of the data lines of the addresses “961” to “1920”), among the RGB data of the first line, are concurrently read respectively from the RAM 30 and from the dual-port RAM 34. Here, the RGB data for the ½ line on the first half side of the first line read from the RAM 30 are outputted to the first source driver group through the selector 42 as the left side RGB data, while the RGB data for the ½ line on the latter half side of the first line read from the dual-port RAM 34 are outputted to the second source driver group as the right side RGB data. In addition, at the time when the read period has ended and when all the RGB data of the first line have been read from the RAM 30 and the dual-port RAM 34, the control unit 36 switches each of the read control signals REN0 and REN2 from the H level to the L level.

The next synchronizing signal is inputted from the graphic processor 20 after a fixed time period from the start of the above read period, and the first predetermined time period further lapses, whereby the next write period (the write period of the RGB data of the second line: a period of a timing t5 to a timing t8 in FIG. 3) arrives midway of the above read period, and the next input of the RGB data of the second line is started by the graphic processor 20. When the next write period has arrived, the control unit 36 switches the write control signal WEN1 from the L level to the H level, and it sequentially generates and outputs changing write addresses in order that the RGB data for ½ line on the first half side sequentially inputted may be written into the single RAM in the first half of the write period (a period of the timing t5 to a timing t6 in FIG. 3). Thus, in the first half of the write period of the RGB data of the second line, only the RAM 32 falls into a writable state, and the write addresses generated and outputted by the control unit 36 are inputted to the RAM 32, whereby the RGB data for the ½ line on the first half side, among the RGB data of the second line sequentially inputted from the graphic processor 20 are written successively from the head of the RAM 32 in the first half of the write period of the RGB data of the second line.

The control unit 36 switches the write control signal WEN1 from the H level to the L level and also switches the write control signal WEN2 from the L level to the H level, at the timing of the end of the first half of the write period (at the timing t6 in FIG. 3), and it sequentially generates and outputs changing write addresses in order that the RGB data for ½ line on the latter half side sequentially inputted may be written into the single RAM in the latter half of the write period (the period t6-t8 in FIG. 3). Thus, in the latter half of the write period of the RGB data of the second line, only the dual-port RAM 34 falls into the writable state, and the write addresses generated and outputted by the control unit 36 are inputted to the dual-port RAM 34, whereby the RGB data for the ½ line on the latter half side, among the RGB data of the second line sequentially inputted from the graphic processor 20 are written successively from the head of the dual-port RAM 34 in the latter half of the write period of the RGB data of the second line.

Here, for the dual-port RAM 34, the read of the RGB data for the ½ line on the latter half side of the first line and the write of the RGB data for the ½ line on the latter half side of the second line are simultaneously (concurrently) performed in the period t6-t7 in FIG. 3. Nevertheless, as understood by comparing the change of the addresses (addresses of the data lines) of the RGB data read from the dual-port RAM 34 and the change of the addresses (addresses of the data lines) of the RGB data written into the dual-port RAM 34, in the period t6-t7 in FIG. 3, the read addresses are not overtaken by the write addresses, and hence, before the RGB data are read, these RGB data are not rewritten into other RGB data (the RGB data of the next line).

In addition, at the time when the write period of the RGB data of the second line has ended and when all the RGB data of the second line sequentially inputted from the graphic processor 20 have been written into the RAM 32 and the dual-port RAM 34 (at the timing t8 in FIG. 3), the control unit 36 switches the write control signal WEN2 from the H level to the L level and also switches the selection signal SEL from the L level to the H level.

When the third predetermined time period has lapsed from the end of the write period of the RGB data of the second line (at a timing t9 in FIG. 3), the control unit 36 switches each of the read control signals REN1 and REN2 from the L level to the H level, and it sequentially generates and outputs changing read addresses in order that the RGB data for ½ line may be read from each individual RAM in the read period of the RGB data of the second line beginning at the switching point of time (a period of the timing t9 to a timing t12 in FIG. 3). Thus, in the period t9-t12 in FIG. 3, the RAM 32 and the dual-port RAM 34 fall into the readable states, and the read addresses generated and outputted by the control unit 36 are respectively inputted to the RAM 32 and the dual-port RAM 34, whereby the RGB data for ½ line on the first half side, among the RGB data of the second line, and the RGB data for ½ line on the latter half side, among the RGB data of the second line, are concurrently read respectively from the RAM 32 and from the dual-port RAM 34. Here, the RGB data for the ½ line on the first half side of the second line read from the RAM 32 are outputted to the first source driver group through the selector 42 as the left side RGB data, while the RGB data for the ½ line on the latter half side of the second line read from the dual-port RAM 34 are outputted to the second source driver group as the right side RGB data.

The next synchronizing signal is inputted from the graphic processor 20 after the fixed time period from the start of the above read period, and the first predetermined time period further lapses, whereby the next write period (the write period of the RGB data of the third line: a period of a timing t10 to a timing t13 in FIG. 3) arrives midway of the above read period, and the next input of the RGB data of the third line is started by the graphic processor 20. When the next write period has arrived, the control unit 36 switches the levels of the selection signal SEL and the write control signals WEN0 and WEN2 at predetermined timings in order that as in the write period of the RGB data of the first line, among the RGB data of the third line sequentially inputted from the graphic processor 20, the RGB data for ½ line on the first half side may be written successively from the head of the RAM 30, in the first half of the write period of the RGB data of the third line, while the RGB data for ½ line on the latter half side may be written successively from the head of the dual-port RAM 34, in the latter half of the write period of the RGB data of the third line.

Thenceforth, in the same manner, in writing the RGB data of an even-numbered line, the control unit 36 switches the levels of the various control signals in order that, as in the write of the RGB data of the second line, the RGB data for ½ line on the first half side may be written successively from the head of the RAM 32, in the first half of the write period of the pertinent data, while the RGB data for ½ line on the latter half side may be written successively from the head of the dual-port RAM 34, in the latter half of the write period of the pertinent data, and in writing the RGB data of an odd-numbered line, the control unit 36 switches the levels of the various control signals in order that, as in the write of the RGB data of the first line, the RGB data for ½ line on the first half side may be written successively from the head of the RAM 30, in the first half of the write period of the pertinent data, while the RGB data for ½ line on the latter half side may be written successively from the head of the dual-port RAM 34, in the latter half of the write period of the pertinent data. Besides, in reading the RGB data of the even-numbered line, the control unit 36 switches the levels of the various control signals in order that, as in the read of the RGB data of the second line, the read of the RGB data for ½ on the first half side, from the RAM 32 and the read of the RGB data for ½ line on the latter half side, from the dual-port RAM 34 may proceed concurrently, and in reading the RGB data of the odd-numbered line, the control unit 36 switches the levels of the various control signals in order that, as in the read of the RGB data of the first line, the read of the RGB data for ½ line on the first half side, from the RAM 30 and the read of the RGB data for ½ line on the latter half side, from the dual-port RAM 34 may proceed concurrently.

As described above, in the first embodiment, only the RAM which stores the RGB data for the ½ line on the first half side, among the RGB data for one line, is dualized (as the RAMs 30 and 32), and the dual-port RAM 34 is disposed as the RAM which stores the RGB data for the ½ line on the latter half side, thereby to realize the concurrence of the distributed outputs of the RGB data for the ½ line, to the two source driver groups. In order to realize the same function, therefore, the related art has required four RAMs each of which is capable of storing RGB data for ½ line (it has required a RAM for 2 lines in terms of the total storage capacity), whereas in the first embodiment, the three RAMs each of which is capable of storing the RGB data for the ½ line suffices (a storage capacity for 1.5 line suffices in terms of the total storage capacity of the RAMs (here, a storage capacity for 0.5 line corresponds to the dual-port RAM), so that the dissipation power of the timing controller 18 can be reduced. Moreover, since the chip size of the timing controller 18 can be made small, reductions in the size and manufacturing cost of the device can be realized.

### Second Embodiment

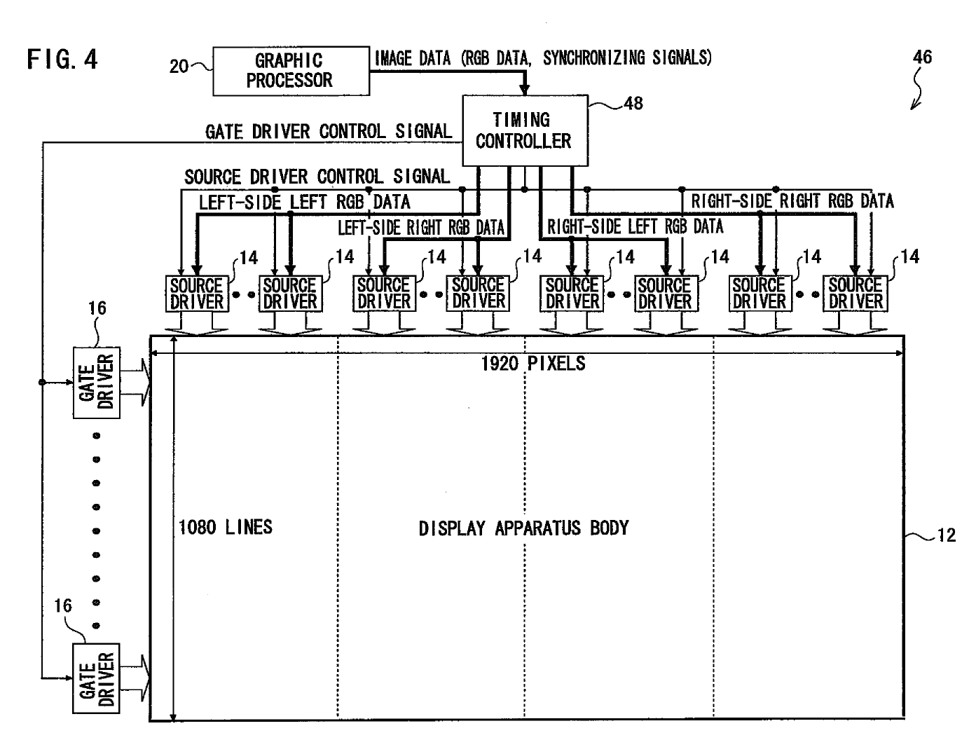

A second embodiment of the present invention will be described. And, the same portions as in the first embodiment are assigned identical numerals, which shall be omitted from description. FIG. 4 shows a display apparatus 46 according to the second embodiment. As compared with the display apparatus 10 described in the first embodiment, the display apparatus 46 according to the second embodiment differs in the points that data lines disposed in the display apparatus body 12 are divided into the four groups of a data line group having addresses “1” to “480”, a data line group having addresses “481” to “960”, a data line group having addresses “961” to “1440”, and a data line group having addresses “1441” to “1920” (three broken lines added to the display apparatus body 12 shown in FIG. 4 signify the positions of divisions into the four data line groups), and that a plurality of source drivers 14 are also divided into the four groups of a first source driver group connected to the data line group having the addresses “1” to “480”, a second source driver group connected to the data line group having the addresses “481” to “960”, a third source driver group connected to the data line group having the addresses “961” to “1440”, and a fourth source driver group connected to the data line group having the addresses “1441” to “1920”.

In addition, as will be explained in detail, a timing controller 48 according to the second embodiment concurrently executes a process in which the RGB data of the data line group having the addresses “1” to “480” (left-side left RGB data) are read from memories and are sequentially outputted to the first source driver group, a process in which the RGB data of the data line group having the addresses “481” to “960” (left-side right RGB data) are read from memories and are sequentially outputted to the second source driver group, a process in which the RGB data of the data line group having the addresses “961” to “1440” (right-side left RGB data) are read from memories and are sequentially outputted to the third source driver group, and a process in which the RGB data of the data line group having the addresses “1441” to “1920” (right-side right RGB data) are read from memories and are sequentially outputted to the fourth source driver group. Thus, the transfer rate of the RGB data from the timing controller 48 to the source drivers 14 is reduced to ¼ of a transfer rate when the above concurrent processes are not executed. In this manner, the first to fourth source driver groups in the second embodiment correspond to drive circuits of k=4, respectively.

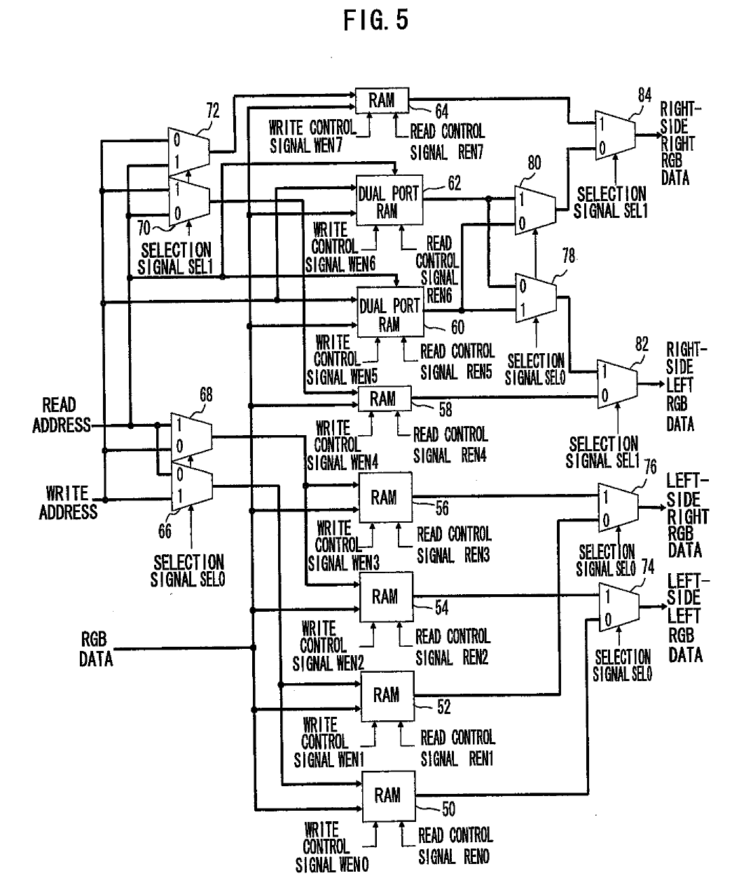

The configuration of (the principal portions of) the timing controller 48 according to the second embodiment will be described with reference to FIG. 5. The timing controller 48 includes four RAMs (single-port RAMs) (RAMs 50, 52, 54 and 56) each of which has a storage capacity capable of storing the drive data of the data lines of ¼ of the total number of the data lines disposed in the display apparatus body 12. As will be explained in detail later, the RGB data of the data line group having the addresses “1” to “480” (the left-side left RGB data) are respectively written into the RAMs 50 and 54, while the RGB data of the data line group having the addresses “481” to “960” (the left-side right RGB data) are respectively written into the RAMs 52 and 56. Accordingly, the RAMs 50 to 56 correspond to pairs of first storage units according to the invention (in more detail, pairs of first storage units) (in this aspect, i=2 is held). Here, the RAMs 50 and 52 constitute one of the first storage units (corresponding to a divided memory of i=2, and “two memories each of which has a storage capacity capable of storing the drive data of the data lines of ¼ of the total number of the data lines”), while the RAMs 54 and 56 constitute the other first storage unit (corresponding to a divided memory of i=2, and “two memories each of which has a storage capacity capable of storing the drive data of the data lines of ¼ of the total number of the data lines”).

The timing controller 48 includes two RAMs (single-port RAMs) 58 and 64 each of which has a storage capacity capable of storing the drive data of the data lines of ⅛ of the total number of the data lines, and two dual-port RAMs 60 and 62 each of which has a storage capacity capable of storing the drive data of the data lines of ¼ of the total number of the data lines. As will be explained in detail later, the right-side left RGB data and the right-side right RGB data of the data line groups having the addresses different from each other are written into the RAMs 58 and 64 and the dual-port RAMs 60 and 62, the total storage capacity of which is a storage capacity capable of storing the drive data of the data lines of ½ of the total number of the data lines. Accordingly, the RAMs 58 and 64 and the dual-port RAMs 60 and 62 correspond to a second storage unit according to the invention (in more detail, a second storage unit) (in this aspect, j=2 is held). Besides, the RAMs 58 and 64 correspond to “two memories each of which has a storage capacity capable of storing the drive data of the data lines of ⅛ of the total number of the data lines”, and the dual-port RAMs 60 and 62 correspond to “two dual-port memories each of which has a storage capacity capable of storing the drive data of the data lines of ⅛ of the total number of the data lines”.

Data lines are connected to the data input terminals of the RAMs 50 to 58 and 64 and the dual-port RAMs 60 and 62, and the RGB data are respectively inputted from a graphic processor 20 through the data lines. Besides, in the second embodiment, the control unit 36 (not shown) of the timing controller 48 generates and outputs write control signals WEN0 to WEN7, read control signals REN0 to REN7, and selection signals SEL0 and SEL1 as various control signals. The write enable input terminal and read enable input terminal of each of the RAMs 50 to 58 and 64 and the dual-port RAMs 60 and 62 are respectively connected to the control unit 36. Thus, the write control signal WEN0 and read control signal REN0 are inputted to the RAM 50, the write control signal WEN1 and read control signal REN1 to the RAM 52, the write control signal WEN2 and read control signal REN2 to the RAM 54, the write control signal WEN3 and read control signal REN3 to the RAM 56, the write control signal WEN4 and read control signal REN4 to the RAM 58, the write control signal WEN5 and read control signal REN5 to the dual-port RAM 60, the write control signal WEN6 and read control signal REN6 to the dual-port RAM 62, and the write control signal WEN7 and read control signal REN7 to the RAM 64. In the second embodiment, the control unit 36 corresponds to a write unit and a read output unit according to the invention (in more detail, a write unit and a read output unit (except the part of “a case of k=2 in terms of the number of drive circuits” in a read output unit)), together with selectors 66 to 84 to be explained below.

The timing controller 48 includes the ten selectors 66 to 84. The two input terminals and the selection signal input terminal of each of the four selectors 66 to 72 are all connected to the control unit 36, and a write address generated by the control unit 36 is inputted to one of the two input terminals of each of the selectors 66 to 72, while a read address generated by the control unit 36 is inputted to the other of the two input terminals of each of the selectors 66 to 72. In addition, the selection signal SEL0 generated by the control unit 36 is inputted to the selection signal input terminal of each of the selectors 66 and 68, while the selection signal SEL1 generated by the control unit 36 is inputted to the selection signal input terminal of each of the selectors 70 and 72. Also, the write address input terminal and read address input terminal of each of the dual-port RAMs 60 and 62 are connected to the control unit 36, and the write address and read address generated by the control unit 36 are inputted to each of the dual-port RAMs 60 and 62. Besides, the output terminal of the selector 66 is connected to the address input terminals of both the RAMs 50 and 52, the output terminal of the selector 68 to the address input terminals of both the RAMs 54 and 56, the output terminal of the selector 70 to the address input terminal of the RAM 58, and the output terminal of the selector 72 to the address input terminal of the RAM 64. Thus, an address outputted from the selector 66 is inputted to the RAMs 50 and 52, an address outputted from the selector 68 is inputted to the RAMs 54 and 56, an address outputted from the selector 70 is inputted to the RAM 58, and an address outputted from the selector 72 is inputted to the RAM 64.

Furthermore, one of the two input terminals of the selector 74 and the other input terminal are respectively connected to the output terminal of the RAM 50 and that of the RAM 54, and data outputted from the RAMs 50 and 54 are respectively inputted to the selector 74. The output terminal of the selector 74 is connected to the first source driver group, and data outputted from the selector 74 are inputted to the first source driver group as the left-side left RGB data. Besides, one of the two input terminals of the selector 76 and the other input terminal are respectively connected to the output terminal of the RAM 52 and that of the RAM 56, and data outputted from the RAMs 52 and 56 are respectively inputted to the selector 76. The output terminal of the selector 76 is connected to the second source driver group, and data outputted from the selector 76 are inputted to the second source driver group as the left-side right RGB data.

One of the two input terminals of each of the selectors 78 and 80 and the other input terminal are respectively connected to the output terminal of the dual-port RAM 60 and that of the dual-port RAM 62, data outputted from the dual-port RAMs 60 and 62 are respectively inputted to the selectors 78 and 80, and the selectors 78 and 80 select and output the data inputted from the different ones of the dual-port RAMs 60 and 62, respectively. In addition, one of the two input terminals of the selector 82 and the other input terminal are respectively connected to the output terminal of the RAM 58 and that of the selector 78, and data outputted from the RAM 58 and the selector 78 are respectively inputted to the selector 82. The output terminal of the selector 82 is connected to the third source driver group, and data outputted from the selector 82 are inputted to the third source driver group as the right-side left RGB data. Further, one of the two input terminals of the selector 84 and the other input terminal are respectively connected to the output terminal of the RAM 64 and that of the selector 80, and data outputted from the RAM 64 and the selector 80 are respectively inputted to the selector 84. The output terminal of the selector 84 is connected to the fourth source driver group, and data outputted from the selector 84 are inputted to the fourth source driver group as the right-side right RGB data.

The selection signal input terminals of the six selectors 74 to 84 explained above are all connected to the control unit 36, and the selection signal SEL0 generated by the control unit 36 is inputted to the respective selection signal input terminals of the four selectors 74 to 80, while the selection signal SEL1 generated by the control unit 36 is inputted to the respective selection signal input terminals of the two selectors 82 and 84.

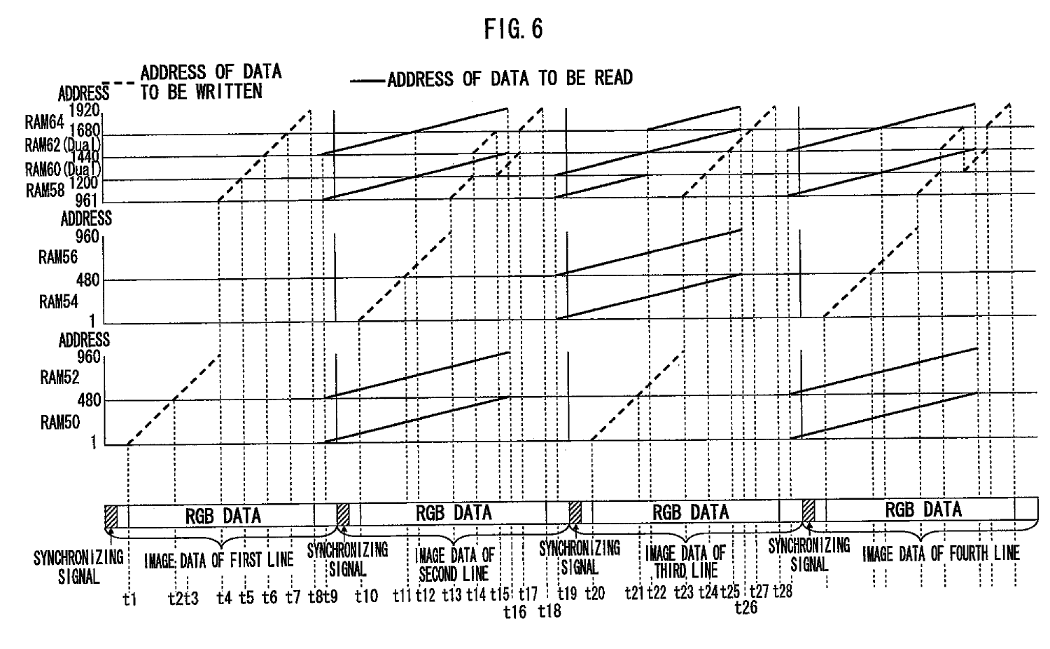

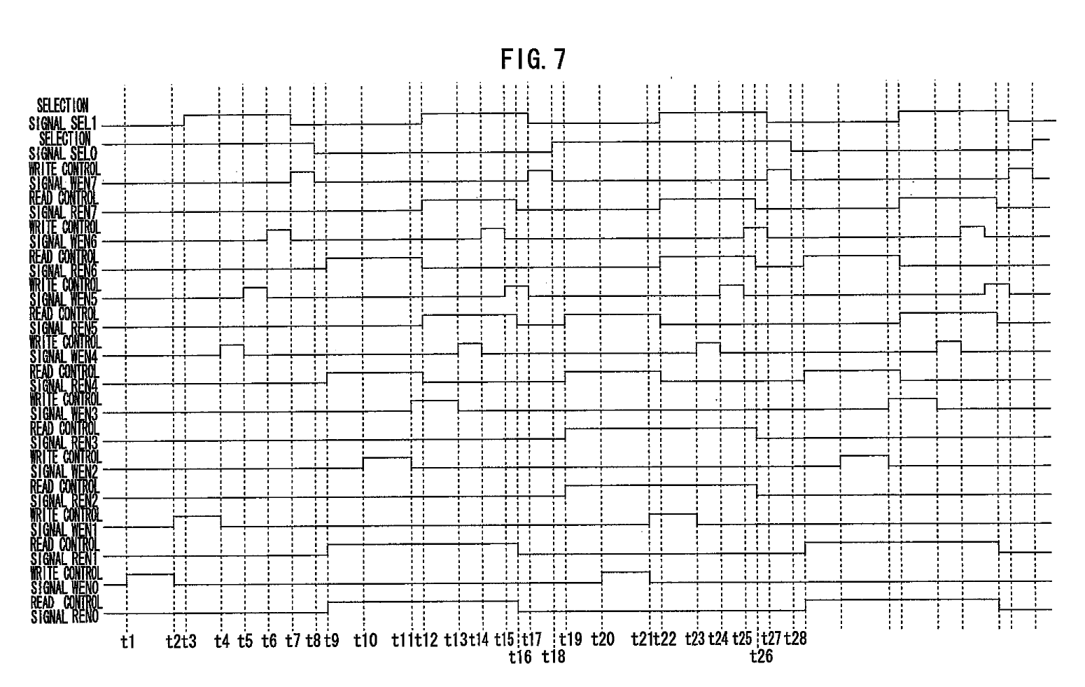

Next the operation of the timing controller 48 according to the second embodiment will be described with reference to FIGS. 6 and 7. As shown in FIG. 7, the various control signals which are generated and outputted by the control unit 36 are such that, at the beginning, the write control signals WEN0 to WEN7, the read control signals REN0 to REN7 and the selection signal SEL1 are at an L level, whereas the selection signal SEL0 is at an H level. The control unit 36 switches the write control signal WEN0 from the L level to the H level after a first predetermined time period from the input of a synchronizing signal (at a timing t1 in FIGS. 6 and 7), and it sequentially generates and outputs changing write addresses in order that, among the RGB data of the first line inputted in the write period of the RGB data of the first line, the RGB data for ¼ line (the RGB data of the data lines having the addresses “1” to “480”) inputted in a period of the start to ¼ of the write period (a period of the timing t1 to a timing t2 in FIGS. 6 and 7) may be all written successively from the head of the single RAM in the pertinent period. Thus, in the period t1-t2 in FIGS. 6 and 7, the RGB data for the ¼ line inputted in the pertinent period are written successively from the head of the RAM 50.

The control unit 36 switches the write control signal WEN0 from the H level to the L level and also switches the write control signal WEN1 from the L level to the H level, at the timing of ¼ of the write period of the RGB data of the first line (at the timing t2 in FIGS. 6 and 7), and it sequentially generates and outputs changing write addresses in order that, among the RGB data of the first line inputted in the write period of the RGB data of the first line, the RGB data for ¼ line (the RGB data of the data lines having the addresses “481” to “960”) inputted in a period of ¼ to ½ of the write period (a period of the timing t2 to a timing t3 in FIGS. 6 and 7) may be all written successively from the head of the single RAM in the pertinent period. Thus, in a period of the timing t2 to a timing t4 in FIGS. 6 and 7, the RGB data for the ¼ line inputted in the pertinent period are written successively from the head of the RAM 52. Besides, the control unit 36 switches the selection signal SEL1 from the L level to the H level at the timing of the lapse of a predetermined time period from ¼ of the write period (at the timing t3 in FIGS. 6 and 7).

The control unit 36 switches the write control signal WEN1 from the H level to the L level and also switches the write control signal WEN4 from the L level to the H level, at the timing of ½ of the write period of the RGB data of the first line (at the timing t4 in FIGS. 6 and 7), and it sequentially generates and outputs changing write addresses in order that, among the RGB data of the first line inputted in the write period of the RGB data of the first line, the RGB data for ⅛ line (the RGB data of the data lines having the addresses “961” to “1200”) inputted in a period of ½ to ⅝ of the write period (a period of the timing t4 to a timing t5 in FIGS. 6 and 7) may be all written successively from the head of the single RAM in the pertinent period. Thus, in the period t4-t5 in FIGS. 6 and 7, the RGB data for the ⅛ line inputted in the pertinent period are written successively from the head of the RAM 58.

The control unit 36 switches the write control signal WEN4 from the H level to the L level and also switches the write control signal WEN5 from the L level to the H level, at the timing of ⅝ of the write period of the RGB data of the first line (at the timing t5 in FIGS. 6 and 7), and it sequentially generates and outputs changing write addresses in order that, among the RGB data of the first line inputted in the write period of the RGB data of the first line, the RGB data for ⅛ line (the RGB data of the data lines having the addresses “1201” to “1440”) inputted in a period of ⅝ to ¾ of the write period (a period of the timing t5 to a timing t6 in FIGS. 6 and 7) may be all written successively from the head of the single RAM in the pertinent period. Thus, in the period t5-t6 in FIGS. 6 and 7, the RGB data for the ⅛ line inputted in the pertinent period are written successively from the head of the dual-port RAM 60.

The control unit 36 switches the write control signal WEN5 from the H level to the L level and also switches the write control signal WEN6 from the L level to the H level, at the timing of ¾ of the write period of the RGB data of the first line (at the timing t6 in FIGS. 6 and 7), and it sequentially generates and outputs changing write addresses in order that, among the RGB data of the first line inputted in the write period of the RGB data of the first line, the RGB data for ⅛ line (the RGB data of the data lines having the addresses “1441” to “1680”) inputted in a period of ¾ to ⅞ of the write period (a period of the timing t6 to a timing t7 in FIGS. 6 and 7) may be all written successively from the head of the single RAM in the pertinent period. Thus, in the period t6-t7 in FIGS. 6 and 7, the RGB data for the ⅛ line inputted in the pertinent period are written successively from the head of the dual-port RAM 62.

In addition, the control unit 36 switches the write control signal WEN6 and the selection signal SEL1 from the H level to the L level and also switches the write control signal WEN7 from the L level to the H level, at the timing of ⅞ of the write period of the RGB data of the first line (at the timing t7 in FIGS. 6 and 7), and it sequentially generates and outputs changing write addresses in order that, among the RGB data of the first line inputted in the write period of the RGB data of the first line, the RGB data for ⅛ line (the RGB data of the data lines having the addresses “1681” to “1920”) inputted in a period of ⅞ to the end of the write period (in a period of the timing t7 to a timing t8 in FIGS. 6 and 7) may be all written successively from the head of the single RAM in the pertinent period. Thus, in the period t7-t8 in FIGS. 6 and 7, the RGB data for the ⅛ line inputted in the pertinent period are written successively from the head of the RAM 64.

In addition, at the time when the write period of the RGB data of the first line has ended and when all the RGB data of the first line have been written into the RAMs 50, 52, 58 and 64 and the dual-port RAMs 60 and 62 (at the timing t8 in FIGS. 6 and 7), the control unit 36 switches the write control signal WEN7 and the selection signal SEL0 from the H level to the L level.

When the third predetermined time period has lapsed from the end of the write period of the RGB data of the first line (at a timing t9 in FIGS. 6 and 7), the control unit 36 switches each of the read control signals REN0, REN1, REN4 and REN6 from the L level to the H level, and it sequentially generates and outputs changing read addresses in order that the RGB data for ¼ line may be read from each individual RAM in the read period of the RGB data of the first line beginning at the point of time t9 (in a period of the timing t9 to a timing t16 in FIGS. 6 and 7) (in this case, the changing rate of the read addresses becomes ¼ of that of the write addresses). Further, the control unit 36 switches each of the read control signals REN4 and REN6 from the H level to the L level and also switches each of the read control signals REN5 and REN7 from the L level to the H level, at the timing of ½ of the read period of the RGB data of the first line (at a timing t12 in FIGS. 6 and 7).

Thus, in the first half of the read period of the RGB data of the first line (the period t9-t12 in FIGS. 6 and 7), the first half data among the RGB data for the ¼ line inputted in the period of the start to ¼ of the write period are read from the RAM 50, the first half data among the RGB data for the ¼ line inputted in the period of ¼ to ½ of the write period are read from the RAM 52, the RGB data for the ⅛ line inputted in the period of ½ to ⅝ of the write period are read from the RAM 58, and the RGB data for the ⅛ line inputted in the period of ¾ to ⅞ of the write period are read from the dual-port RAM 62, in concurrent fashion. Here, the RGB data read from the RAM 50 are outputted to the first source driver group through the selector 74 as the left-side left RGB data, the RGB data read from the RAM 52 are outputted to the second source driver group through the selector 76 as the left-side right RGB data, the RGB data read from the RAM 58 are outputted to the third source driver group through the selector 82 as the right-side left RGB data, and the RGB data read from the dual-port RAM 62 are outputted to the fourth source driver group through the selectors 80 and 84 as the right-side right RGB data.

In the latter half period of the read period of the RGB data of the first line (the period t12-t16 in FIGS. 6 and 7), the latter half data among the RGB data for the ¼ line inputted in the period of the start to ¼ of the write period are read from the RAM 50, the latter half data among the RGB data for the ¼ line inputted in the period of ¼ to ½ of the write period are read from the RAM 52, the RGB data for the ⅛ line inputted in the period of ⅝ to ¾ of the write period are read from the dual-port RAM 60, and the RGB data for the ⅛ line inputted in the period of ⅞ to the end of the write period are read from the RAM 64, in concurrent fashion. Here, the RGB data read from the RAM 50 are outputted to the first source driver group through the selector 74 as the left-side left RGB data, the RGB data read from the RAM 52 are outputted to the second source driver group through the selector 76 as the left-side right RGB data, the RGB data read from the dual-port RAM 60 are outputted to the third source driver group through the selectors 78 and 82 as the right-side left RGB data, and the RGB data read from the RAM 64 are outputted to the fourth source driver group through the selector 84 as the right-side right RGB data.

In addition, at the time when the read period has ended and when all the RGB data of the first line have been read from the RAMs 50, 52, 58 and 64 and the dual-port RAMs 60 and 62 (at the timing t16 in FIGS. 6 and 7), the control unit 36 switches each of the read control signals REN0, REN1, REN5 and REN7 from the H level to the L level.

The next synchronizing signal is inputted from the graphic processor 20 after a fixed time period from the start of the read period of the RGB data of the first line, and the first predetermined time period further lapses, whereby the write period of the RGB data of the second line (a period of a timing t10 to a timing t18 in FIGS. 6 and 7) arrives midway of the read period of the RGB data of the first line, and the next input of the RGB data of the second line is started by the graphic processor 20. When the write period of the RGB data of the second line has arrived, the control unit 36 switches the write control signal WEN2 from the L level to the H level, and it sequentially generates and outputs changing write addresses in order that, among the RGB data of the second line inputted in the write period of the RGB data of the second line, the RGB data for ¼ line inputted in a period of the start to ¼ of the write period (a period of the timing t10 to a timing t11 in FIGS. 6 and 7) may be all written successively from the head of the single RAM in the pertinent period. Thus, in the period t10-t11 in FIGS. 6 and 7, the RGB data for the ¼ line inputted in the pertinent period are written successively from the head of the RAM 54.

The control unit 36 switches the write control signal WEN2 from the H level to the L level and also switches the write control signal WEN3 from the L level to the H level, at the timing of ¼ of the write period of the RGB data of the second line (at the timing t11 in FIGS. 6 and 7), and it sequentially generates and outputs changing write addresses in order that, among the RGB data of the second line inputted in the write period of the RGB data of the second line, the RGB data for ¼ line inputted in a period of ¼ to ½-period of the write period (a period of the timing t11 to a timing t13 in FIGS. 6 and 7) may be all written successively from the head of the single RAM in the pertinent period. Thus, in the period t11-t13 in FIGS. 6 and 7, the RGB data for the ¼ line inputted in the pertinent period are written successively from the head of the RAM 56. In addition, the control unit 36 switches the selection signal SEL1 from the L level to the H level at the timing of the lapse of the fixed time period from ¼ of the write period (at the timing t12 in FIGS. 6 and 7).

The control unit 36 switches the write control signal WEN3 from the H level to the L level and also switches the write control signal WEN4 from the L level to the H level, at the timing of ½ of the write period of the RGB data of the second line (the timing t13 in FIGS. 6 and 7), and it sequentially generates and outputs changing write addresses in order that, among the RGB data of the second line inputted in the write period of the RGB data of the second line, the RGB data for ⅛ line inputted in a period of ½ to ⅝-period of the write period (a period of the timing t13 to a timing t14 in FIGS. 6 and 7) may be all written successively from the head of the single RAM in the pertinent period. Thus, in the period t13-t14 in FIGS. 6 and 7, the RGB data for the ⅛ line inputted in the pertinent period are written successively from the head of the RAM 58.

Furthermore, the control unit 36 switches the write control signal WEN4 from the H level to the L level and also switches the write control signal WEN6 from the L level to the H level, at the timing of ⅝ of the write period of the RGB data of the first line (the timing t14 in FIGS. 6 and 7), and it sequentially generates and outputs changing write addresses in order that, among the RGB data of the second line inputted in the write period of the RGB data of the second line, the RGB data for ⅛ line inputted in a period of ⅝ to ¾ of the write period (a period of the timing t14 to a timing t15 in FIGS. 6 and 7) may be all written successively from the head of the single RAM in the pertinent period. Thus, in the period t14-t15 in FIGS. 6 and 7, the RGB data for the ⅛ line inputted in the pertinent period are written successively from the head of the dual-port RAM 62.

The control unit 36 further switches the write control signal WEN6 from the H level to the L level and also switches the write control signal WEN5 from the L level to the H level, at the timing of ¾ of the write period of the RGB data of the second line (the timing t15 in FIGS. 6 and 7), and it sequentially generates and outputs changing write addresses in order that, among the RGB data of the second line inputted in the write period of the RGB data of the second line, the RGB data for ⅛ line inputted in a period of ¾ to ⅞ of the write period (a period of the timing t15 to a timing t17 in FIGS. 6 and 7) may be all written successively from the head of the single RAM in the pertinent period. Thus, in the period t15-t17 in FIGS. 6 and 7, the RGB data for the ⅛ line inputted in the pertinent period are written successively from the head of the dual-port RAM 60.

Here, for the dual-port RAM 60, the read of the RGB data and the write of the RGB data are simultaneously (concurrently) performed in the period t15-t16 in FIGS. 6 and 7. Nevertheless, as understood by comparing the change of the addresses (addresses of the data lines) of the RGB data read from the dual-port RAM 60 and the change of the addresses (addresses of the data lines) of the RGB data written into the dual-port RAM 60, in the period t15-t17 in FIGS. 6 and 7, the read addresses are not overtaken by the write addresses, and hence, before the RGB data are read, these RGB data are not rewritten into other RGB data (the RGB data of the next line).

The control unit 36 switches each of the write control signal WEN5 and the selection signal SEL1 from the H level to the L level and also switches the write control signal WEN7 from the L level to the H level, at the timing of ⅞ of the write period of the RGB data of the second line (the timing t17 in FIGS. 6 and 7), and it sequentially generates and outputs changing write addresses in order that, among the RGB data of the second line inputted in the write period of the RGB data of the second line, the RGB data for ⅛ line inputted in a period of ⅞ to the end of the write period (a period t17-t18 in FIGS. 6 and 7) may be all written successively from the head of the single RAM in the pertinent period. Thus, in the period t17-t18 in FIGS. 6 and 7, the RGB data for the ⅛ line inputted in the pertinent period are written successively from the head of the RAM 64.

In addition, at the time when the write period of the RGB data of the second line has ended and when all the RGB data of the second line have been written into the RAMs 54, 56, 58 and 64 and the dual-port RAMs 60 and 62 (at the timing t18 in FIGS. 6 and 7), the control unit 36 switches the write control signal WEN7 from the H level to the L level and also switches the selection signal SEL0 from the L level to the H level.

When the third predetermined time period has lapsed from the end of the write period of the RGB data of the second line (at a timing t19 in FIGS. 6 and 7), the control unit 36 switches each of the read control signals REN2, REN3, REN4 and REN5 from the L level to the H level, and it sequentially generates and outputs changing read addresses in order that the RGB data for ¼ line may be read from each individual RAM in the read period of the RGB data of the second line beginning at the point of time t19 (in a period of the timing t19 to a timing t26 in FIGS. 6 and 7). Further, the control unit 36 switches each of the read control signals REN4 and REN5 from the H level to the L level and also switches each of the read control signals REN6 and REN7 from the L level to the H level, at the timing of ½ of the read period of the RGB data of the second line (at a timing t22 in FIGS. 6 and 7).

Thus, in the first half of the read period of the RGB data of the second line (the period t19-t22 in FIGS. 6 and 7), the first half data among the RGB data for the ¼ line inputted in the period of the start to ¼ of the write period are read from the RAM 54, the first half data among the RGB data for the ¼ line inputted in the period of ¼ to ½ of the write period are read from the RAM 56, the RGB data for the ⅛ line inputted in the period of ½ to ⅝ of the write period are read from the RAM 58, and the RGB data for the ⅛ line inputted in the period of ¾ to ⅞ of the write period are read from the dual-port RAM 60, in concurrent fashion. Here, the RGB data read from the RAM 54 are outputted to the first source driver group through the selector 74 as the left-side left RGB data, the RGB data read from the RAM 56 are outputted to the second source driver group through the selector 76 as the left-side right RGB data, the RGB data read from the RAM 58 are outputted to the third source driver group through the selector 82 as the right-side left RGB data, and the RGB data read from the dual-port RAM 60 are outputted to the fourth source driver group through the selectors 80 and 84 as the right-side right RGB data.

In the latter half of the read period of the RGB data of the second line (the period t22-t26 in FIGS. 6 and 7), the latter half data among the RGB data for the ¼ line inputted in the period of the start to ¼ of the write period are read from the RAM 54, the latter half data among the RGB data for the ¼ line inputted in the period of ¼ to the ½ of the write period are read from the RAM 56, the RGB data for the ⅛ line inputted in the period of ⅝ to ¾ of the write period are read from the dual-port RAM 62, and the RGB data for the ⅛ line inputted in the period of ⅞ to the end of the write period are read from the RAM 64, in concurrent fashion. Here, the RGB data read from the RAM 54 are outputted to the first source driver group through the selector 74 as the left-side left RGB data, the RGB data read from the RAM 56 are outputted to the second source driver group through the selector 76 as the left-side right RGB data, the RGB data read from the dual-port RAM 60 are outputted to the third source driver group through the selectors 78 and 82 as the right-side left RGB data, and the RGB data read from the RAM 64 are outputted to the fourth source driver group through the selector 84 as the right-side right RGB data.

In addition, at the time when the read period has ended and when all the RGB data of the second line have been read from the RAMs 50, 52, 58 and 64 and the dual-port RAMs 60 and 62 (at the timing t26 in FIGS. 6 and 7), the control unit 36 switches each of the read control signals REN2, REN3, REN6 and REN7 from the H level to the L level.

The next synchronizing signal is inputted from the graphic processor 20 after the fixed time period from the start of the read period of the RGB data of the second line, and the first predetermined time period further lapses, whereby the write period of the RGB data of the third line (a period of a timing t20 to a timing t28 in FIGS. 6 and 7) arrives midway of the read period of the RGB data of the second line, and the next input of the RGB data of the third line is started by the graphic processor 20. When the write period of the RGB data of the third line has arrived, the control unit 36 switches the levels of the selection signals SEL0 and SEL1 and the write control signals WEN0, WEN1, WEN4, WEN5, WEN6 and WEN7 at predetermined timings in order that, as in the write period of the RGB data of the first line, among the RGB data of the third line sequentially inputted from the graphic processor 20, the RGB data for ¼ line inputted in the period of the start to ¼ the write period may be written into the RAM 50, that the RGB data for the ¼ line inputted in the period of ¼ to ½ of the write period may be written into the RAM 52, that the RGB data for the ⅛ line inputted in the period of ½ to ⅝ of the write period may be written into the RAM 58, that the RGB data for the ⅛ line inputted in the period of ⅝ to ¾ of the write period may be written into the dual-port RAM 60, that the RGB data for the ⅛ line inputted in the period of ¾ to the ⅞ of the write period may be written into the dual-port RAM 62, and that the RGB data for the ⅛ line inputted in the period of ⅞ to the end of the write period may be written into the RAM 64.

Thenceforth, in the same manner, in writing the RGB data of an even-numbered line, the control unit 36 switches the levels of the various control signals in order that, as in the write of the RGB data of the second line, the RGB data for ¼ line inputted in a period of the start to ¼ of a write period may be written into the RAM 54, that the RGB data for ¼ line inputted in a period of ¼ to ½ of the write period may be written into the RAM 56, that the RGB data for ⅛ line inputted in a period of ½ to ⅝ of the write period may be written into the RAM 58, that the RGB data for ⅛ line inputted in a period of ⅝ to ¾ of the write period may be written into the dual-port RAM 62, that the RGB data for ⅛ line inputted in a period of ¾ to ⅞ of the write period may be written into the dual-port RAM 60, and that the RGB data for ⅛ line inputted in a period of ⅞ to the end of the write period may be written into the RAM 64. On the other hand, in writing the RGB data of an odd-numbered line, the control unit 36 switches the levels of the various control signals in order that, as in the write of the RGB data of the first line, the RGB data for ¼ line inputted in a period of the start to ¼ of the write period may be written into the RAM 50, that the RGB data for ¼ line inputted in a period of ¼ to ½ of the write period may be written into the RAM 52, that the RGB data for ⅛ line inputted in a period of ½ to ⅝ of the write period may be written into the RAM 58, that the RGB data for ⅛ line inputted in a period of ⅝ to ¾ of the write period may be written into the dual-port RAM 60, that the RGB data for ⅛ line inputted in a period of ¾ to ⅞ of the write period may be written into the dual-port RAM 62, and that the RGB data for ⅛ line inputted in a period of ⅞ to the end of the write period may be written into the RAM 64.

In reading the RGB data of the even-numbered line, the control unit 36 switches the levels of the various control signals in order that, as in the read of the RGB data of the second line, the reads of the RGB data from the RAMs 54, 56 and 58 and the dual-port RAM 60 may proceed concurrently in the first half of a read period, while the reads of the RGB data from the RAMs 54, 56 and 64 and the dual-port RAM 62 may proceed concurrently in the latter half of the read period. On the other hand, in reading the RGB data of the odd-numbered line, the control unit 36 switches the levels of the various control signals in order that, as in the read of the RGB data of the first line, the reads of the RGB data from the RAMs 50, 52 and 58 and the dual-port RAM 62 may proceed concurrently in the first half of the read period, while the reads of the RGB data from the RAMs 50, 52 and 64 and the dual-port RAM 60 may proceed concurrently in the latter half of the read period.

As described above, in the second embodiment, only the RAMs which store the RGB data for the ½ line on the first half side, among the RGB data for one line, are dualized (as the RAMs 50 to 56), and the RAMs 58 and 64 and the dual-port RAMs 60 and 62, each of which has a storage capacity capable of storing the RGB data for the ⅛ line, are disposed as the RAMs which store the RGB data for the ½ line on the latter half side, thereby to realize the concurrence of the distributed outputs of the RGB data for the ¼ line, to the four source driver groups. Therefore, a storage capacity for 1.5 line suffices in terms of the total storage capacity of the RAMs for realizing the above function, and the dissipation power of the timing controller 48 can be reduced. Moreover, the total storage capacity of the dual-port RAMs can be reduced to ½ as compared with that in the first embodiment, and the chip size of the timing controller 48 can be made still smaller, so that further reductions in the size and manufacturing cost of the device can be realized.

In the second embodiment, the write sequence of the drive data for the RAMs 58 and 64 and the dual-port RAMs 60 and 62 being a plurality of memories which constitute the second storage unit according to the invention is switched every cycle. Therefore, the read addresses from the dual-port RAMs 60 and 62 can be prevented from being overtaken by the write addresses into these dual-port RAMs 60 and 62, in the periods for which the drive data are being simultaneously read from and written into these dual-port RAMs 60 and 62. And, apart from the switching of the write sequence in every cycle as stated above, the prevention of the read addresses from being overtaken by the write addresses can be realized in such a way that the read speed of the drive data from each memory in each cycle is enhanced so as to make the read period of the drive data in each cycle shorter than a predetermined value (whereby the periods for which the drive data are being simultaneously read from and written into the dual-port RAMs can be shortened). It is also allowed to conjointly employ the switching of the write sequence in every cycle and the enhancement of the read speed.

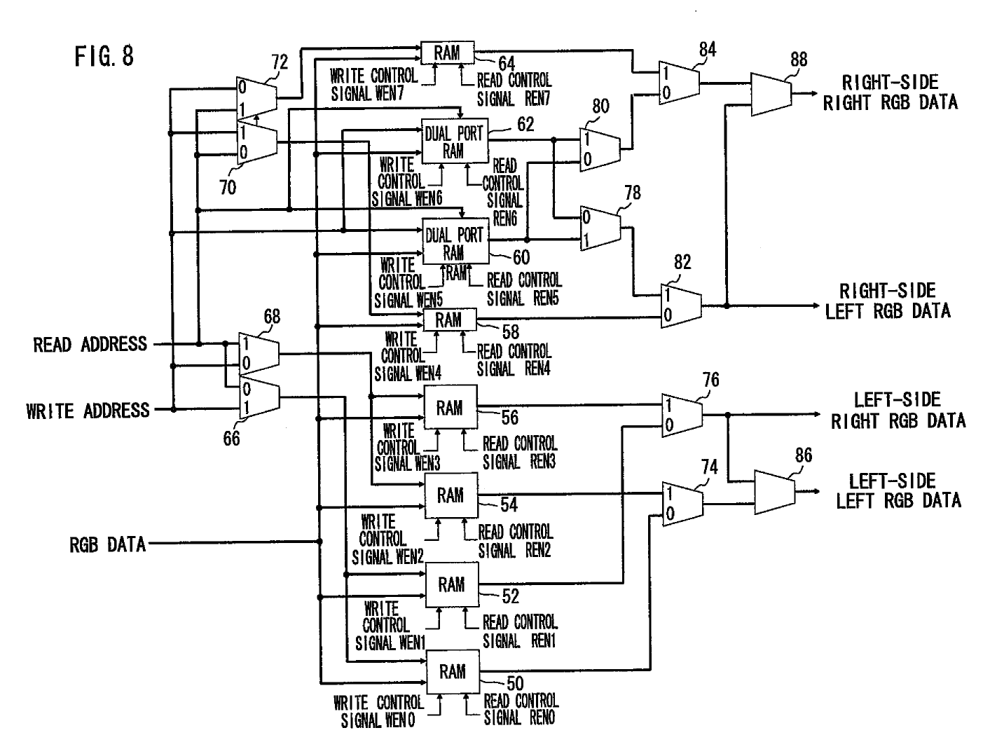

And, as shown in FIG. 8, the timing controller 48 according to the second embodiment may well be provided with a selector 86, one and the other of the two input terminals of which are respectively connected to the output terminal of the selector 74 and that of the selector 76, and a selector 88, one and the other of the two input terminals of which are respectively connected to the output terminal of the selector 82 and that of the selector 84. Thus, operations can be switched in order that, when the data lines and source drivers 14 of the display apparatus body 12 are divided into the four groups as shown in FIG. 4, the distributed outputs of the RGB data for the ¼ line, to the respective ones of the four source driver groups may be concurrently performed, while when the data lines and source drivers 14 of the display apparatus body 12 are divided into the two groups as shown in FIG. 1, the distributed outputs of the RGB data for the ½ line, to the two source driver groups may be concurrently performed.

More specifically, when the data lines and source drivers 14 of the display apparatus body 12 are divided into the four groups, the control unit 36 switches the various control signals at the timings explained in the second embodiment (the timings shown in FIG. 7), and it inputs selection signals to the selectors 86 and 88 in order that the selector 86 may always output data inputted from the selector 74, while the selector 88 may always output data inputted from the selector 84. Thus, the timing controller shown in FIG. 8 operates so that the distributed outputs of the RGB data for the ¼ line, to the respective ones of the four source driver groups may proceed concurrently as explained in the second embodiment.

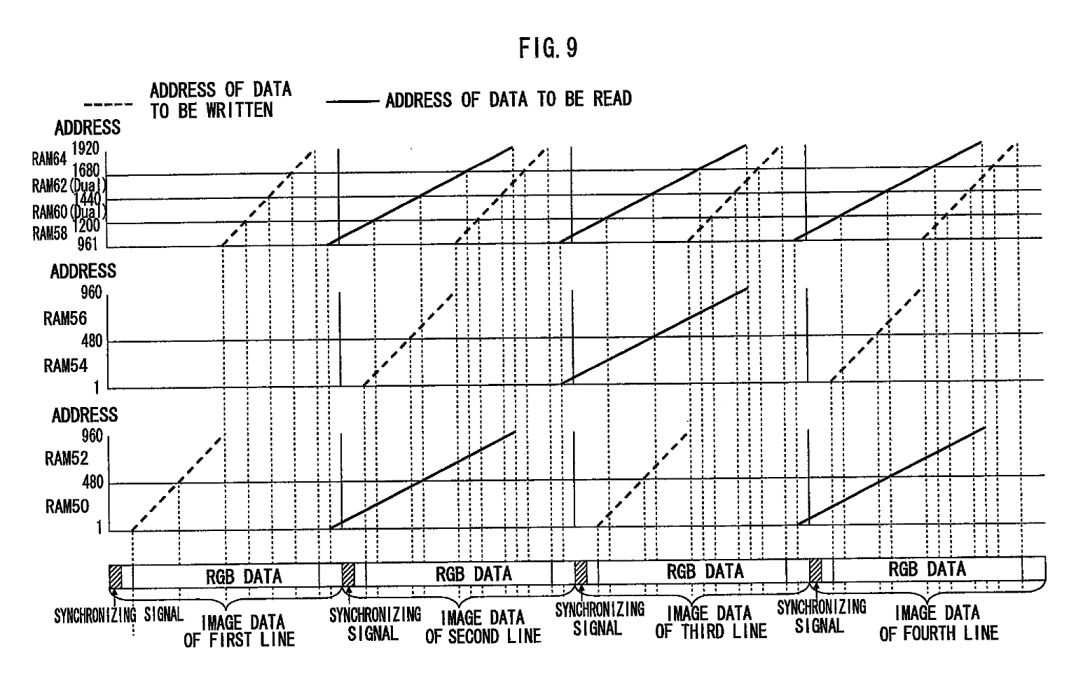

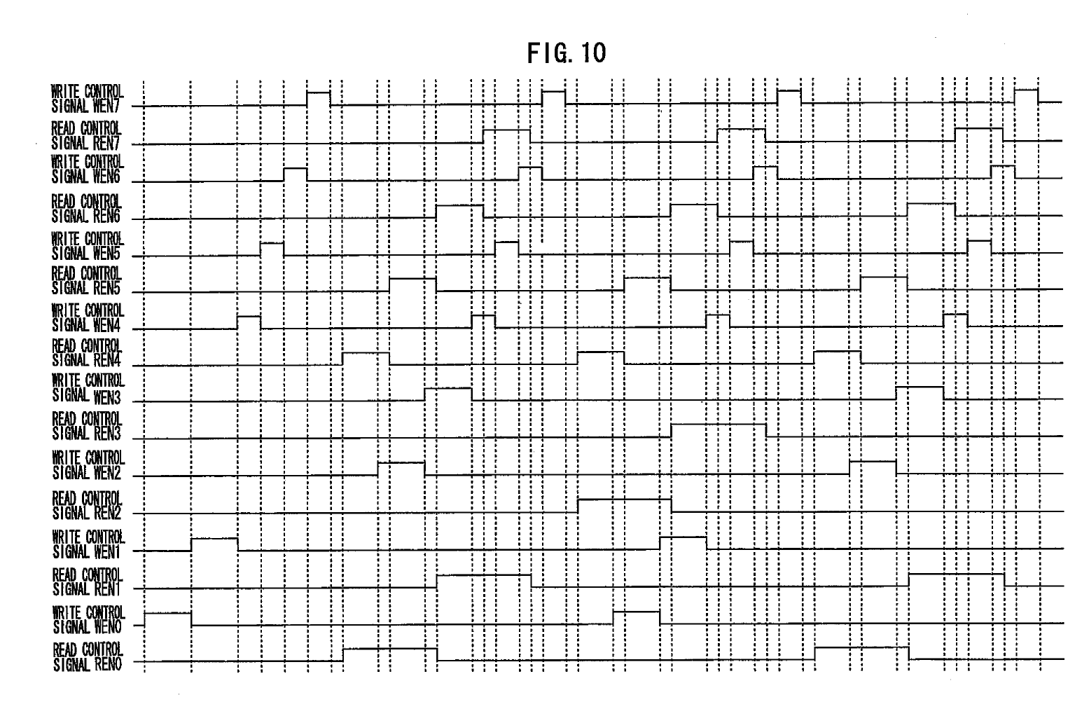

When the data lines and source drivers 14 of the display apparatus body 12 are divided into the two groups, the control unit 36 switches the levels of the various control signals as shown in FIGS. 9 and 10. In more detail, in writing the RGB data of an odd-numbered line, the control unit 36 switches the levels of the various control signals in order that the RGB data for ¼ line inputted in a period of the start to ¼ of a write period may be written into the RAM 50, that the RGB data for ¼ line inputted in a period of ¼ to ½ of the write period may be written into the RAM 52, that the RGB data for ⅛ line inputted in a period of ½ to ⅝ of the write period may be written into the RAM 58, that the RGB data for ⅛ line inputted in a period of ⅝ to ¾ of the write period may be written into the dual-port RAM 60, that the RGB data for ⅛ line inputted in a period of ¾ to the ⅞ of the write period may be written into the dual-port RAM 62, and that the RGB data for ⅛ line inputted in a period of ⅞ to the end of the write period may be written into the dual-port RAM 64. In writing the RGB data of an even-numbered line, the control unit 36 switches the levels of the various control signals in order that the RGB data for ¼ line inputted in a period of the start to ¼ of the write period may be written into the RAM 54, that the RGB data for ¼ line inputted in a period of ¼ to ½ of the write period may be written into the RAM 56, that the RGB data for ⅛ line inputted in a period of ½ to the ⅝ of the write period may be written into the RAM 58, that the RGB data for ⅛ line inputted in a period of ⅝ to ¾ of the write period may be written into the dual-port RAM 60, that the RGB data for ⅛ line inputted in a period of ¾ to ⅞ of the write period may be written into the dual-port RAM 62, and that the RGB data for ⅛ line inputted in a period of ⅞ to the end of the write period may be written into the RAM 64.

In reading the RGB data of the odd-numbered line, the control unit 36 switches the levels of the various control signals in order that the reads of the RGB data from the RAM 50 and the RAM 58 may proceed concurrently in a period of the start to ¼ of a read period, that the reads of the RGB data from the RAM 50 and the dual-port RAM 60 may proceed concurrently in a period of ¼ to ½ of the read period, that the reads of the RGB data from the RAM 52 and the dual-port RAM 62 may proceed concurrently in a period of ½ to ¾ of the read period, and that the reads of the RGB data from the RAM 52 and the RAM 64 may proceed concurrently in a period of ¾ to the end of the read period. Further, in reading the RGB data of the even-numbered line, the control unit 36 switches the levels of the various control signals in order that the reads of the RGB data from the RAM 54 and the RAM 58 may proceed concurrently in a period of the start to ¼ of the read period, that the reads of the RGB data from the RAM 54 and the dual-port RAM 60 may proceed concurrently in a period of ¼ to ½ of the read period, that the reads of the RGB data from the RAM 56 and the dual-port RAM 62 may proceed concurrently in a period of ½ to ¾ of the read period, and that the reads of the RGB data from the RAM 56 and the RAM 64 may proceed concurrently in a period of ¾ to the end of the read period.

And, regarding the selectors 86 and 88, the data are always outputted from only either of the selectors 74 and 76 and either of the selectors 82 and 84 in the above read operation when the data lines and the source drivers 14 are divided into the two groups, so that the selectors 86 and 88 may be switched so as to output the inputted data as they are. As understood from the fact that, owing to the above operation of the control unit 36, the changes of the addresses in FIG. 9 are the same as in FIG. 3, the timing controller shown in FIG. 8 operates so as to concurrently perform the distributed outputs of the RGB data for the ½ line, to the respective ones of the two source driver groups.

Accordingly, owing to the configuration shown in FIG. 8 in which the selectors 86 and 88 are added to the timing controller 48 according to the second embodiment it is permitted to switch the operating mode in which the distributed outputs of the RGB data for the ½ line, to the respective ones of the two source driver groups are concurrently performed, and the operating mode in which the distributed outputs of the RGB data for the ¼ line, to the respective ones of the four source driver groups are concurrently performed. And, the control unit 36 in FIG. 8 corresponds to both a write unit and a read output unit, together with the selectors 66 to 88.

In the above, there has been described the aspect in which the number of divisions of data lines and source drivers is set at 2 or 4, and in which only a RAM that stores RGB data for ½ line on the first half side, among RGB data for one line, is dualized (as a pair of first storage units), while only a dual-port RAM, or a dual-port RAM and a RAM is/are disposed as a RAM (a second storage unit) that stores RGB data for ½ line on the latter half side. However, the number of divisions of the data lines and the source drivers or the storage capacities of the pair of first storage units and the second storage unit is/are not limited to the values mentioned before, but the configuration is, of course, alterable on occasion within a scope forming no hindrance to the invention, in such a way, for example, that the number of divisions (k) of the data lines and the source drivers is set at 5, and that the storage capacity of the pair of first storage units is set at ⅗ line (i=3), while the storage capacity of the second storage unit is set at ⅖ line (j=2).

1. A data distribution device connected to k (where k≧2) drive circuits which are respectively disposed in correspondence with individual data line groups in which data lines disposed in a display apparatus are divided into data line groups numbering k, and the k drive circuits drive the individual data lines of the respectively corresponding data line groups, comprising:
a pair of first storage units, each of which having a storage capacity capable of storing drive data of data line groups numbering i (where i<k);
a second storage unit which comprises a dual-port memory capable of simultaneously writing and reading data, and which has a storage capacity capable of storing the drive data of j (where j=k−i) data line groups;
a write unit which repeatedly writes, from among the drive data of all the data lines of the display apparatus inputted every cycle from a data source in a fixed sequence, the drive data for the i data line groups from the start thereof in the fixed input sequence, into one of the pair of first storage units, and thereafter writes the remaining drive data of j data line groups into the second storage unit such that at least drive data which are in a memory at which reading and writing of drive data takes place during the same period are written into the dual-port memory of the second storage unit, and alternates every cycle the one of the pair of first storage units into which the drive data are written; and
a read output unit which, after completion of the writing of the drive data by the write unit, concurrently reads the drive data to be outputted to the k drive circuits, from the one of the pair of first storage units into which the latest drive data have been written, and from the second storage unit, and which outputs the respective concurrently read drive data to the k corresponding drive circuits concurrently;
wherein read addresses read from the dual-port memory are not overtaken by write addresses written to the dual-port memory during the period in which reading and writing of the drive data are being simultaneously performed with respect to the dual-port memory of the second storage unit.

2. The data distribution device of claim 1, wherein:
the second storage unit is comprised only of the dual-port memory;
the write unit writes all the remaining drive data into the dual-port memory of the second storage unit; and
the read output unit concurrently performs a first read process in which the drive data to be outputted to the i drive circuits are read from the first storage unit into which the latest drive data have been written, and a second read process in which the drive data to be outputted to the j drive circuits are read from the dual-port memory of the second storage unit, thereby concurrently reading the drive data which are to be outputted to the k drive circuits.

3. The data distribution device of claim 1, wherein:
the second storage unit comprises the dual-port memory and a memory;
the write unit separates and writes the remaining drive data respectively into the dual-port memory and the memory of the second storage unit such that, from among the remaining drive data, at least drive data which are in a memory at which reading and writing of drive data takes place during the same period are written into the dual-port memory of the second storage unit, while the other drive data are written into the memory of the second storage unit; and
the read output unit concurrently performs a first read process in which the drive data to be outputted to the i drive circuits are read from the first storage unit into which the latest drive data have been written, and a second read process in which the drive data to be outputted to the j drive circuits are read from the second storage unit comprising of the dual-port memory and the memory, thereby concurrently reading the drive data which are to be outputted to the k drive circuits.

4. The data distribution device of claim 2, wherein:
when the number of the drive circuits k and the number i are constant and the number i is 2 or larger, or when the value of the number i varies according to the number of the drive circuits k and the maximum of i is 2 or larger, each of the pair of first storage units is divided into m memories, where m is equal to the value of the constant number of i or the maximum number of i, each memory having a storage capacity capable of storing the drive data of all the data lines of a single data line group;
the write unit writes the drive data for the i data line groups from the start thereof in the input sequence from the data source, successively into the m memories of one of the pair of the first storage units; and
when the value of i is at least 2, the read output unit performs the first read process, in which successive drive data, to be outputted to the i drive circuits, is read concurrently from each of the m memories, which are formed when the first storage unit, where the latest drive data are written, is divided into the m memories.

5. The data distribution device of claim 3, wherein:
when the number of the drive circuits k and the number i are constant and the number i is 2 or larger, or when the value of the number i varies according to the number of the drive circuits k and the maximum of i is 2 or larger, each of the pair of first storage units is divided into m memories, where m is equal to the value of the constant number of i or the maximum number of i, each memory having a storage capacity capable of storing the drive data of all the data lines of a single data line group;
the write unit writes the drive data for the i data line groups from the start thereof in the input sequence from the data source, successively into the m memories of one of the pair of the first storage units; and
when the value of i is at least 2, the read output unit performs the first read process, in which successive drive data, to be outputted to the i drive circuits, is read concurrently from each of the m memories, which are formed when the first storage unit, where the latest drive data are written, is divided into the m memories.

6. The data distribution device of claim 1, wherein, every cycle, the write unit changes sequences of the plurality of memories that form the second storage unit and that include the dual-port memory into which the drive data are written, such that the read addresses read from the dual-port memory are not overtaken by the write addresses written to the dual-port memory during a period in which the reading and writing of the drive data are being simultaneously performed with respect to the dual-port memory of the second storage unit.

7. The data distribution device of claim 2, wherein, every cycle, the write unit changes sequences of the plurality of memories that form the second storage unit and that include the dual-port memory into which the drive data are written, such that the read addresses read from the dual-port memory are not overtaken by the write addresses written to the dual-port memory during a period in which the reading and writing of the drive data are being simultaneously performed with respect to the dual-port memory of the second storage unit.

8. The data distribution device of claim 3, wherein, every cycle, the write unit changes sequences of the plurality of memories that form the second storage unit and that include the dual-port memory into which the drive data are written, such that the read addresses read from the dual-port memory are not overtaken by the write addresses written to the dual-port memory during a period in which the reading and writing of the drive data are being simultaneously performed with respect to the dual-port memory of the second storage unit.

9. The data distribution device of claim 4, wherein, every cycle, the write unit changes sequences of the plurality of memories that form the second storage unit and that include the dual-port memory into which the drive data are written, such that the read addresses read from the dual-port memory are not overtaken by the write addresses written to the dual-port memory during a period in which the reading and writing of the drive data are being simultaneously performed with respect to the dual-port memory of the second storage unit.

10. The data distribution device of claim 5, wherein, every cycle, the write unit changes sequences of the plurality of memories that form the second storage unit and that include the dual-port memory into which the drive data are written, such that the read addresses read from the dual-port memory are not overtaken by the write addresses written to the dual-port memory during a period in which the reading and writing of the drive data are being simultaneously performed with respect to the dual-port memory of the second storage unit.

11. The data distribution device of claim 1, wherein the read output unit reads the drive data at a preset read speed such that the length of a drive data read period in every cycle is shorter than or equal to a predetermined length, such that the read addresses from the dual-port memory are not overtaken by the write addresses into the dual-port memory during a period in which the reading and writing of the drive data are being simultaneously performed with respect to the dual-port memory of the second storage unit.

12. The data distribution device of claim 2, wherein the read output unit reads the drive data at a preset read speed such that the length of a drive data read period in every cycle is shorter than or equal to a predetermined length, such that the read addresses from the dual-port memory are not overtaken by the write addresses into the dual-port memory during a period in which the reading and writing of the drive data are being simultaneously performed with respect to the dual-port memory of the second storage unit.

13. The data distribution device of claim 3, wherein the read output unit reads the drive data at a preset read speed such that the length of a drive data read period in every cycle is shorter than or equal to a predetermined length, such that the read addresses from the dual-port memory are not overtaken by the write addresses into the dual-port memory during a period in which the reading and writing of the drive data are being simultaneously performed with respect to the dual-port memory of the second storage unit.

14. The data distribution device of claim 4, wherein the read output unit reads the drive data at a preset read speed such that the length of a drive data read period in every cycle is shorter than or equal to a predetermined length, such that the read addresses from the dual-port memory are not overtaken by the write addresses into the dual-port memory during a period in which the reading and writing of the drive data are being simultaneously performed with respect to the dual-port memory of the second storage unit.

15. The data distribution device of claim 5, wherein the read output unit reads the drive data at a preset read speed such that the length of a drive data read period in every cycle is shorter than or equal to a predetermined length, such that the read addresses from the dual-port memory are not overtaken by the write addresses into the dual-port memory during a period in which the reading and writing of the drive data are being simultaneously performed with respect to the dual-port memory of the second storage unit.

16. The data distribution device of claim 3, wherein:
when the number of the drive circuits k is 2 or 4;
each of the pair of first storage units comprises two memories, each of which having a storage capacity capable of storing the drive data of the data lines of ¼ of the total number of the data lines disposed in the display apparatus;
the second storage unit comprises two dual-port memories, each of which having a storage capacity capable of storing the drive data of the data lines of ⅛ of the total number of the data lines, and two memories, each of which having a storage capacity capable of storing the drive data of the data lines of ⅛ of the total number of the data lines;
the write unit writes the drive data for the data lines of ½ of the total number of the data lines, from the starts thereof in the input sequence from the data source, successively into the two memories of one of the pair of first storage units, writes the drive data for the next ⅛ of the data lines into one of the two memories of the second storage unit, writes the drive data for the next ⅛ of the data lines into one of the two dual-port memories of the second storage unit, writes the drive data for the next ⅛ of the data lines into the other of the two dual-port memories of the second storage unit, and writes the drive data for the final ⅛ of the data lines into the other of the two memories of the second storage unit; and
when the number of the drive circuits k is 2, the read output unit performs the first read process in which the drive data to be outputted to the single drive circuit are successively read from those two memories of the first storage unit into which the latest drive data has been written, and it performs the second read process, which is concurrent with the first read process, and in which the drive data to be outputted to the single drive circuit are successively read from one of the two memories of the second storage unit, from one of the two dual-port memories of the second storage unit, from the other of the two dual-port memories of the second storage unit and from the other of the two memories of the second storage unit, and
when the number of the drive circuits k is 4, the read output unit performs the first read process in which the drive data to be outputted to the two drive circuits are read from those two memories of the first storage unit into which the latest drive data have been written, and it performs the second read process, which is concurrent with the first read process, and in which the drive data to be outputted to the single drive circuit are successively read from one of the two memories of the second storage unit and from one of the two dual-port memories of the second storage unit, while the drive data to be outputted to the single drive circuit are successively read from the other of the two dual-port memories of the second storage unit and from the other of the two memories of the second storage unit.

17. A data distribution method, in which drive data of all data lines of a display apparatus are inputted in a fixed sequence from a data source every cycle and are distributed to k (where k≧2) drive circuits respectively disposed in correspondence with individual data line groups, and wherein data lines disposed in the display apparatus are divided into k data line groups, and which drive the individual data lines of the respectively corresponding data line groups, comprising:
repeatedly writing, from among the drive data of all the data lines of the display apparatus that are inputted every cycle from the data source in the fixed sequence, drive data of the i (where i<k) data line groups from the start thereof, in a fixed input sequence into one of the pair of first storage units, each of which has a storage capacity capable of storing the drive data of the i data line groups, and thereafter writing the remaining drive data of j data line groups (where j=k−i) into a second storage unit which comprises a dual-port memory capable of simultaneously writing and reading data and which has a storage capacity capable of storing the drive data for the j data line groups, such that at least the drive data which are in a memory at which reading and writing of drive data takes place during the same period, are written into the dual-port memory of the second storage unit, and alternating every cycle the one of the pair of first storage units into which the drive data are written; and
concurrently reading after completion of the writing of the drive data by the write unit, the drive data to be outputted to the k drive circuits, from the one of the pair of first storage units into which the latest drive data have been written, and from the second storage unit, and concurrently outputting the concurrently read respective drive data, to the k corresponding drive circuits.
